(19) United States
(12) Patent Application Publication
(10) Pub. No.: US 2023/0392017 A1
(43) Pub. Date: Dec. 7, 2023

(54) A REACTIVE DYE COMPOUND AND PREPARATION METHOD AND APPLICATION THEREOF

(71) Applicants: ZHEJIANG KEYONG CHEMICAL CO., LTD., Shaoxing (CN); SHANGHAI KEHUA DYESTUFF INDUSTRY CO., LTD., Shanghai (CN); ZHEJIANG LONGSHENG GROUP CO., LTD., Shaoxing, Zhejiang (CN)

(72) Inventors: Xubin He, Shaoxing (CN); Zhuan Wang, Shaoxing (CN); Quanhui He, Shaoxing (CN); Peng Zhao, Shaoxing (CN); Jianliang Shen, Shaoxing (CN); Shuyi Fang, Shaoxing (CN)

(21) Appl. No.: 18/249,954

(22) PCT Filed: Jul. 6, 2021
(86) PCT No.: PCT/CN2021/104710

§ 371 Date: Apr. 20, 2023

(30) Foreign Application Priority Data
Dec. 26, 2020 (CN) 202011570930.2

(51) Int. Cl. C09B 62/01; D06P 1/38

(52) U.S. Cl. CPC C09B 62/01; D06P 1/38

(57) ABSTRACT

A reactive dye compound and preparation method and application thereof. The reactive dye compound is a compound of the following formula (I) or an alkali metal salt thereof, in formula (I), D¹ and D² are each independently the group of the following formula (a) or (b). The reactive dye compound is capable of applying in printing and dyeing of cellulosic fibers, polyamide fibers or their fabrics. The reactive dye compound of the present invention has a novel structure, good washing fastness and rubbing fastness, and good fiber-bonding stability, and are suitable for dyeing and printing of fibers such as cotton, rayon, silk, viscose, and wool.

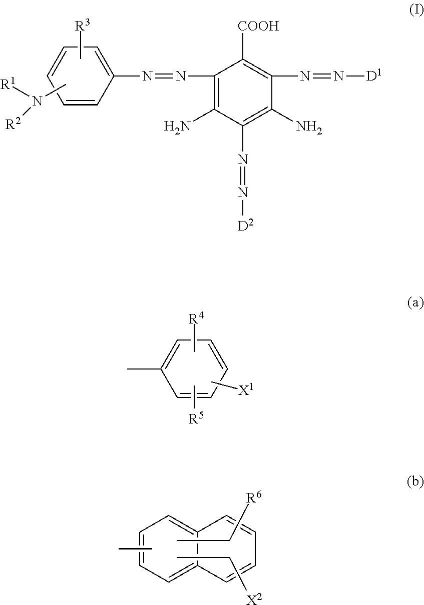

### TECHNICAL FIELD

The present invention relates to a reactive dye compound, in particular to a reactive dye compound and its preparation method and application in printing and dyeing of cellulosic fibers, polyamide fibers and their fabrics.

### BACKGROUND ART

Extension of conjugated system of dyes is beneficial for improving their substantativity, thereby improving their dye-uptake and degree of fixation. There are also many reports on the development of new polyazo reactive dyes in the prior art, such as the published patents CN1266869A, CN105694530A and CN101319096A. Due to the increase of conjugated system, degrees of exhaustion and fixation increased a lot, but their fastnesses to washing and rubbing are not good, especially the color fastness to washing and staining is not able to meet the production requirements well.

In order to solve the above problems, the inventors developed a new structure of polyazo reactive dyes, used 3,5-dihydroxybenzoic acid as a coupling component and carried out intensive research on the compounds. On the basis of a large number of experiments, we obtained polyazo reactive dyes with excellent properties such as good fastnesses to washing and rubbing.

### SUMMARY OF THE INVENTION

The first object of the present invention is to provide reactive dye compounds with novel structure and excellent properties.

The second object of the present invention is to provide a preparation method of the above reactive dye compounds.

The third object of the present invention is to provide an application of the reactive dye compounds in printing and dyeing of cellulosic fibers, polyamide fibers and their fabrics.

The technical solutions adopted by the present invention are specifically described as follows.

In the first aspect, the present invention provides a reactive dye compound, which is a compound of the following formula (I) or an alkali metal salt thereof:

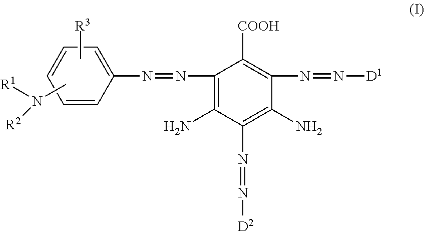

in formula (I):
D¹ and D² are each independently the group of the following formula (a) or (b):

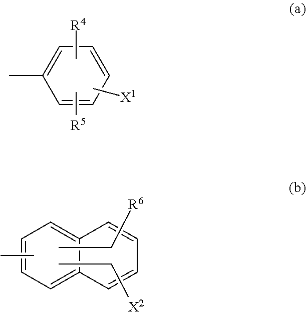

in the above formulae (I), (a) and (b):
R¹ and R² are each independently hydrogen, oxygen, —COR⁷, C₁˜C₄ alkyl or C₁˜C₄ alkyl substituted by hydroxyl, sulfo or carboxyl, in which R⁷ is C₁˜C₄ alkyl, C₂˜C₄ alkenyl or —NH₂;
R³ is hydrogen, C₁˜C₄ alkyl, C₁˜C₄ alkoxy, carboxyl or sulfo;
R⁴˜R⁶ are each independently hydrogen, C₁˜C₄ alkyl, C₁˜C₄ alkoxy or sulfo;
X¹ and X² are each independently —SO₂Y¹, —NHCO(CH₂)ₚSO₂Y² or —CONH(CH₂)_{q}SO₂Y³, wherein Y¹˜Y³ are each independently —CH═CH₂, —CH₂CH₂OSO₃H or —CH₂CH₂Cl, p=1-3 and q=1-3.

In the present invention, the C₁˜C₄ alkyl may be methyl, ethyl, n-propyl, isopropyl, n-butyl, isobutyl, tert-butyl, etc.; the C₁˜C₄ alkoxy may be methoxy, ethoxy, n-propoxy, isopropoxy, n-butoxy, isobutoxy, tert-butoxy, etc.

Preferably, both D¹ and D² are the group of formula (a) or (b). More preferably, both D¹ and D² are the group of formula (a).

Preferably, R¹ and R² are each independently hydrogen, —COR⁷, in which R⁷ is methyl or —NH₂.

Preferably, R³ is preferably hydrogen, methyl, methoxy, carboxyl or sulfo.

Preferably, R⁴R⁶ are each independently hydrogen, methyl, methoxy or sulfo.

Preferably, X¹ and X² are each independently —SO₂Y¹, —NHCOCH₂CH₂SO₂Y² or —CONHCH₂CH₂SO₂Y³, wherein Y¹˜Y³ are each independently —CH═CH₂ or —CH₂CH₂OSO₃H.

More preferably, the group of formula (a) is selected from the group consisting of the following groups:

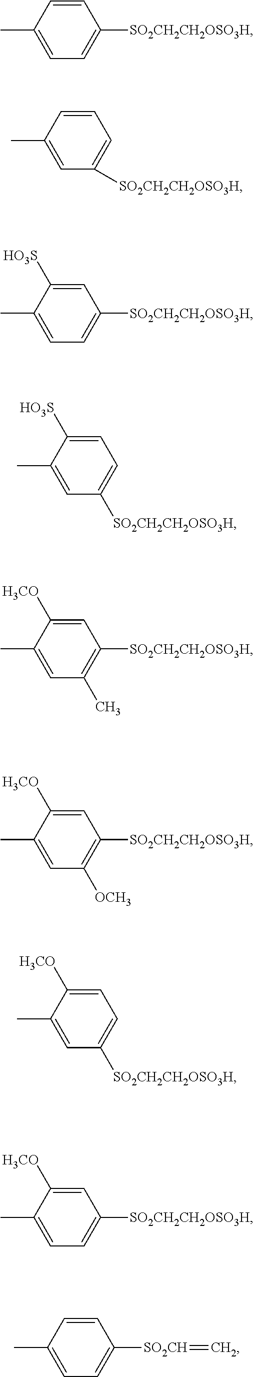

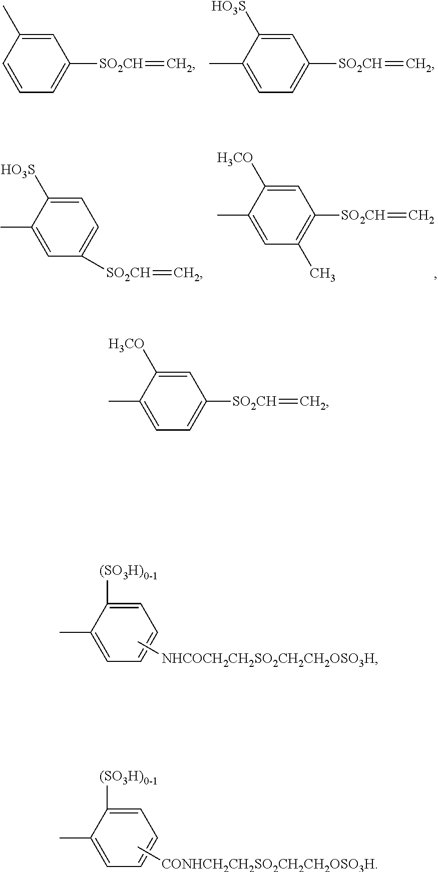

More preferably, the group of formula (b) is selected from the group consisting of the following groups:

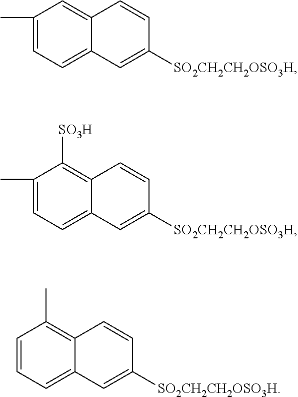

The present invention specifically recommends that the compound of formula (I) be selected from the group consisting of the following structures:

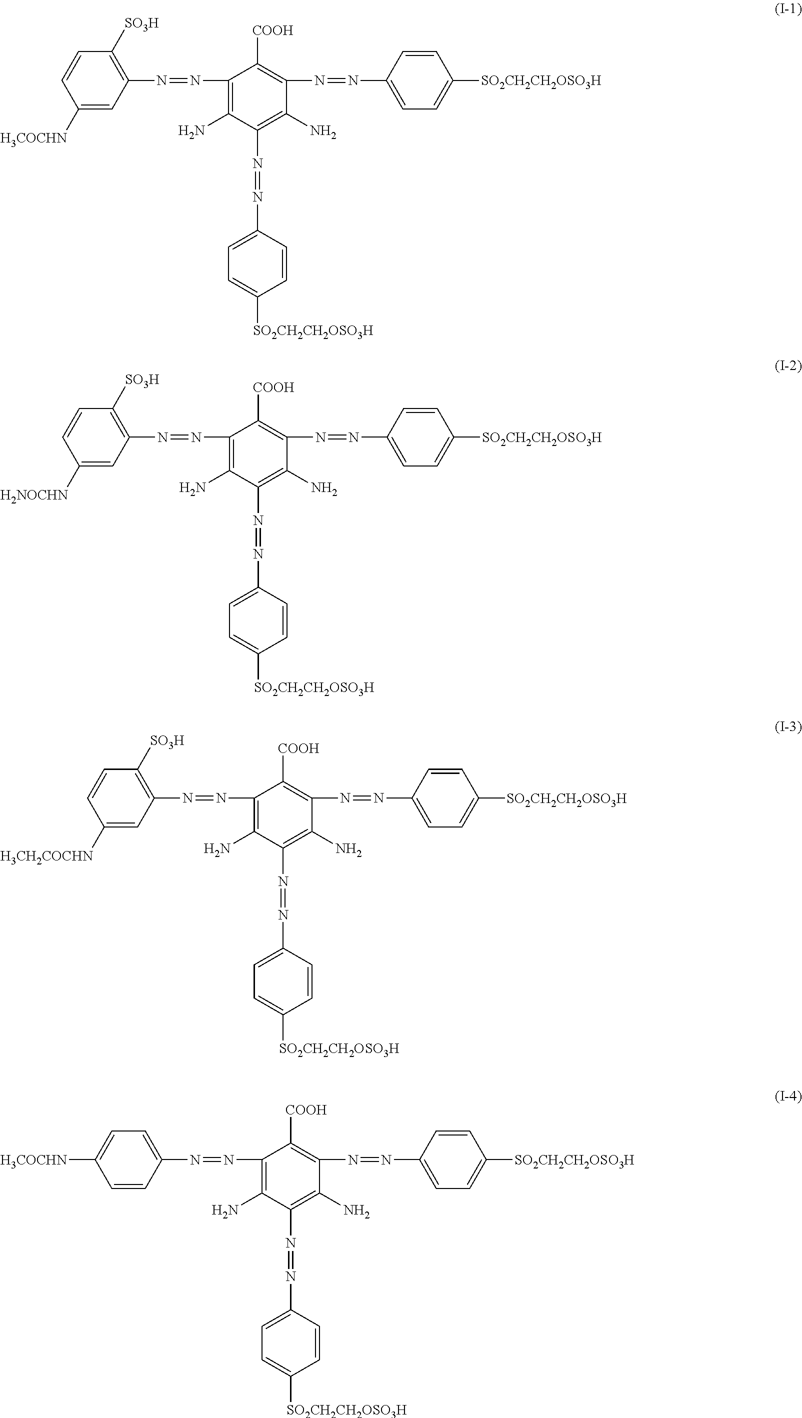

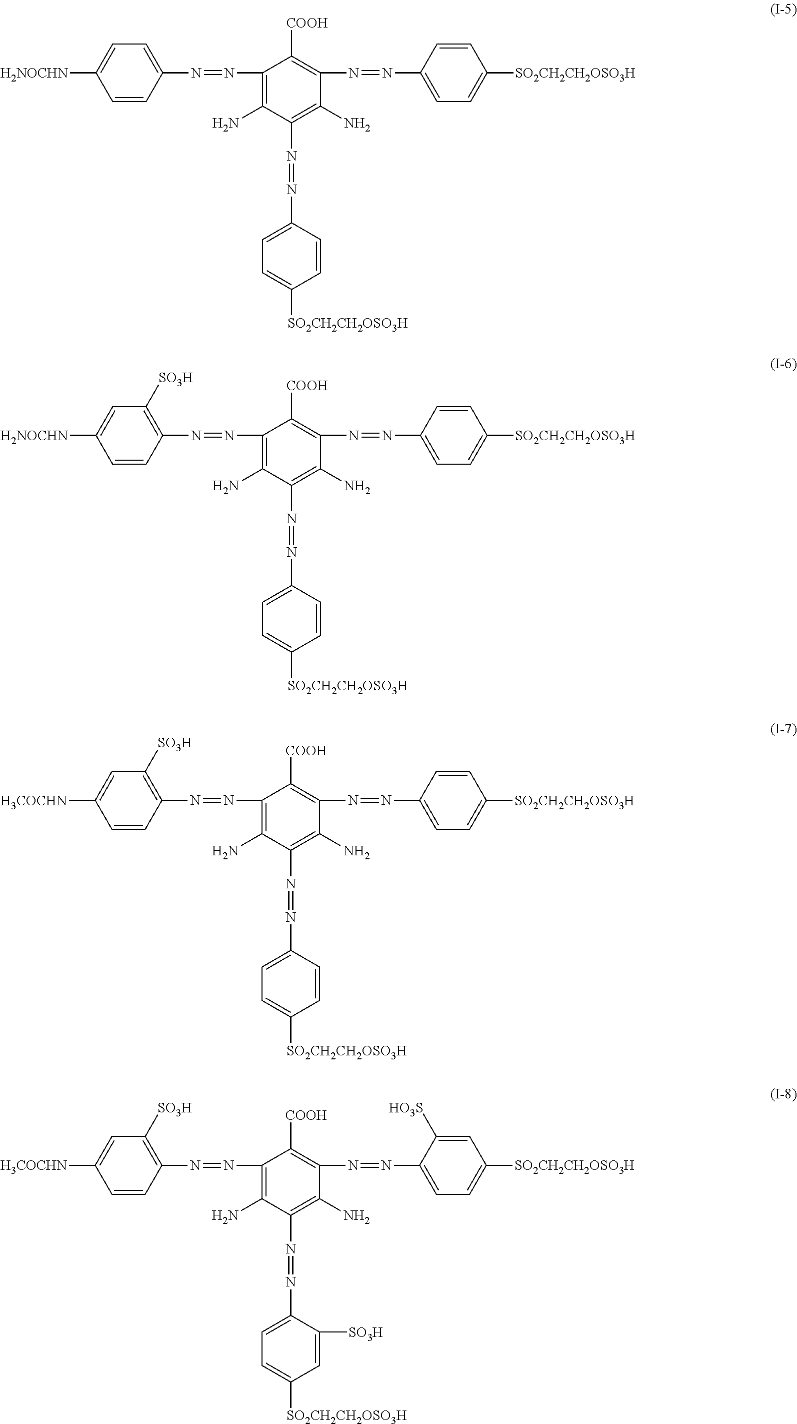

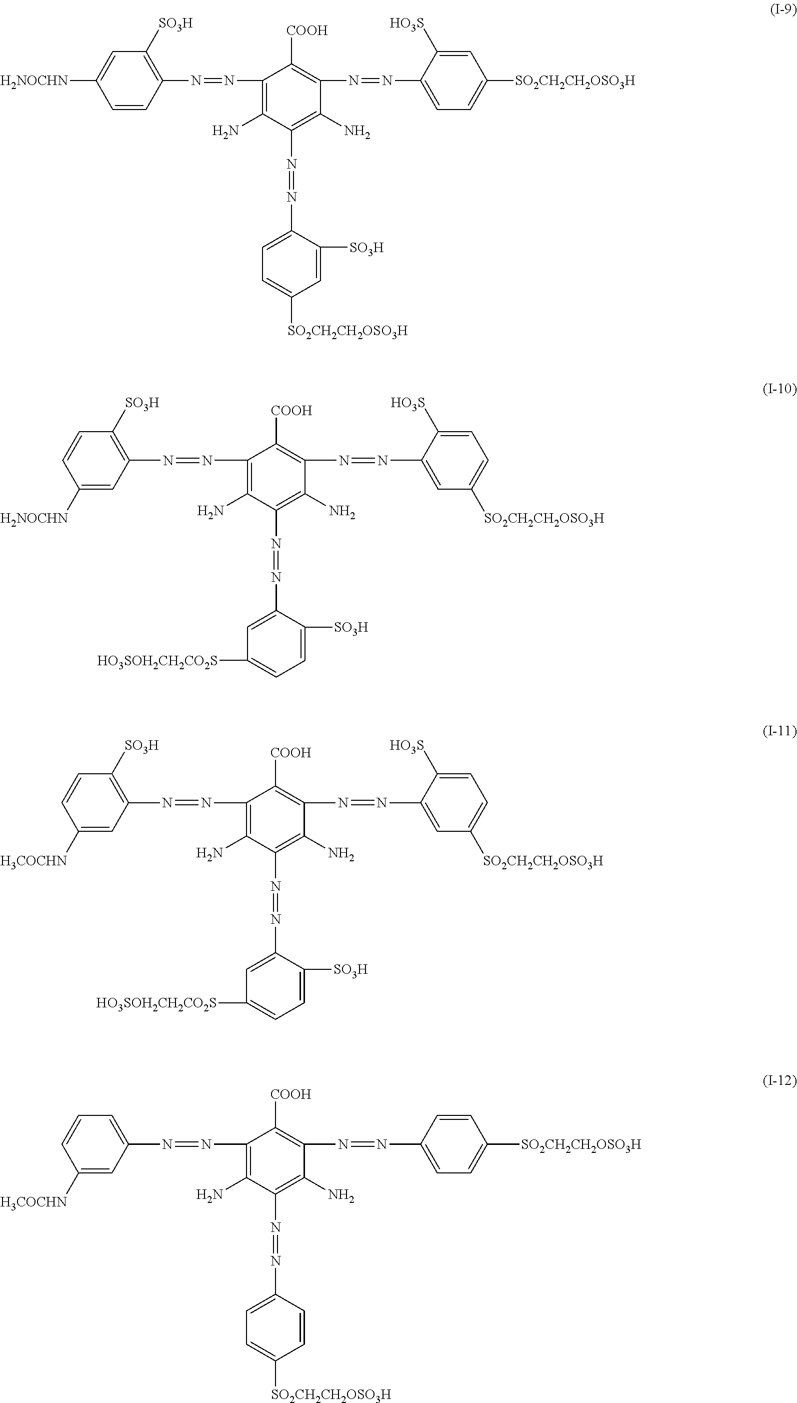

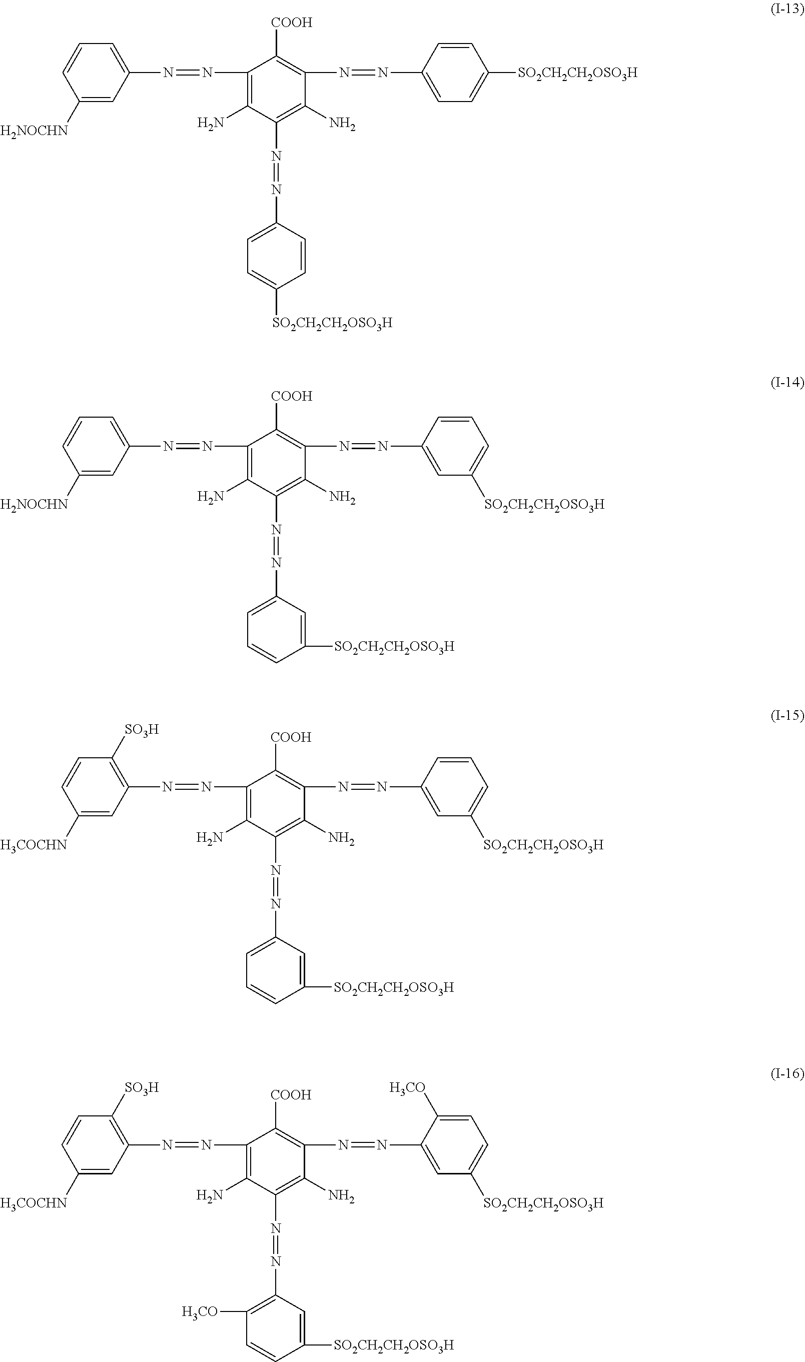

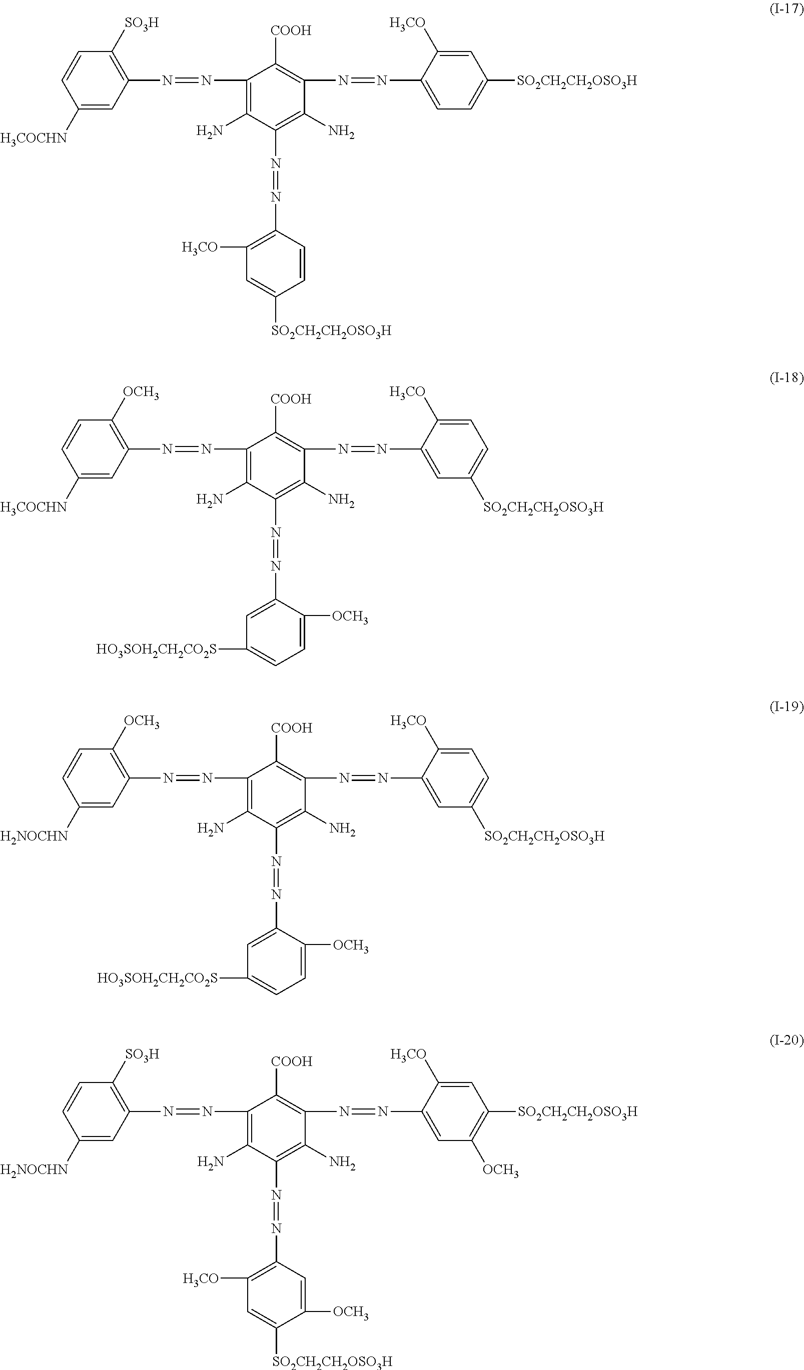

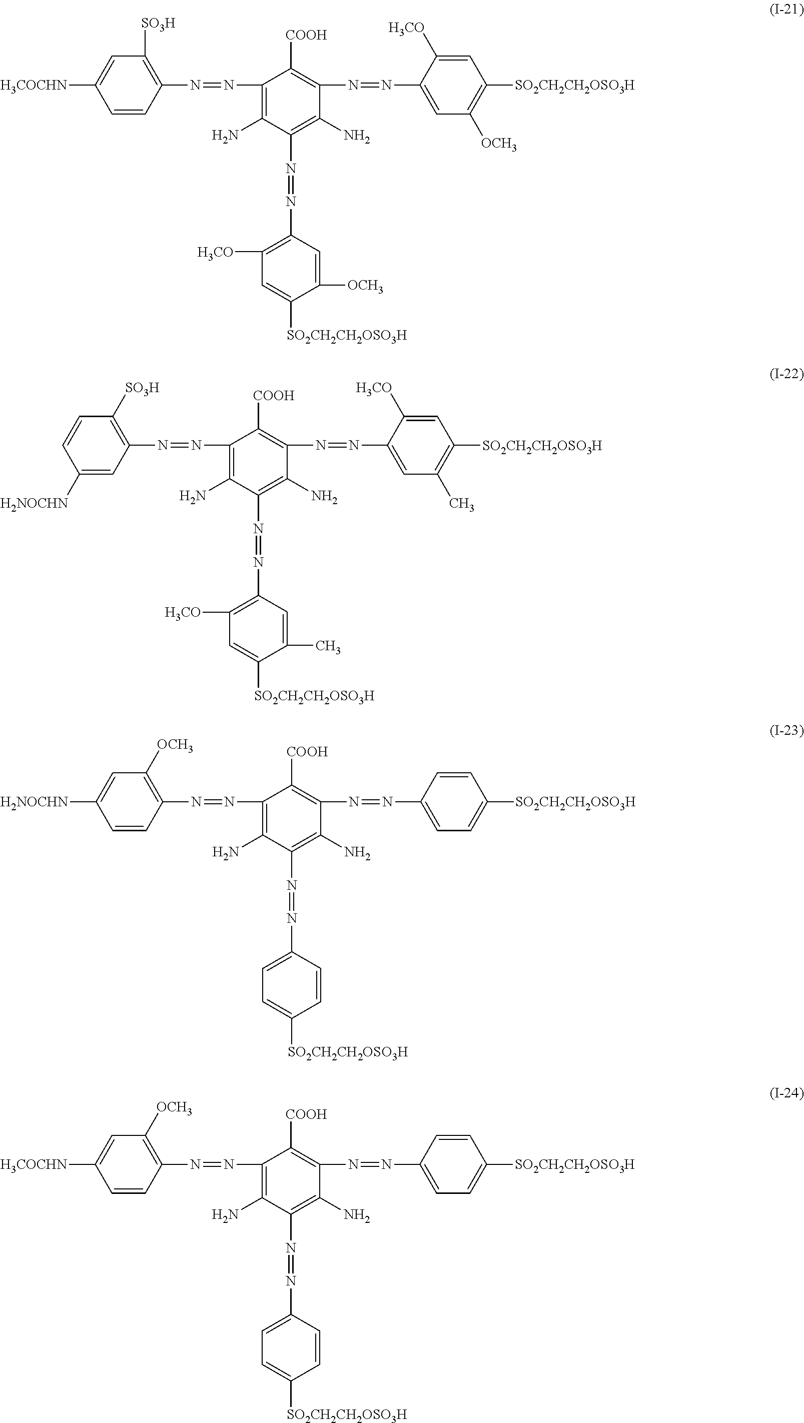

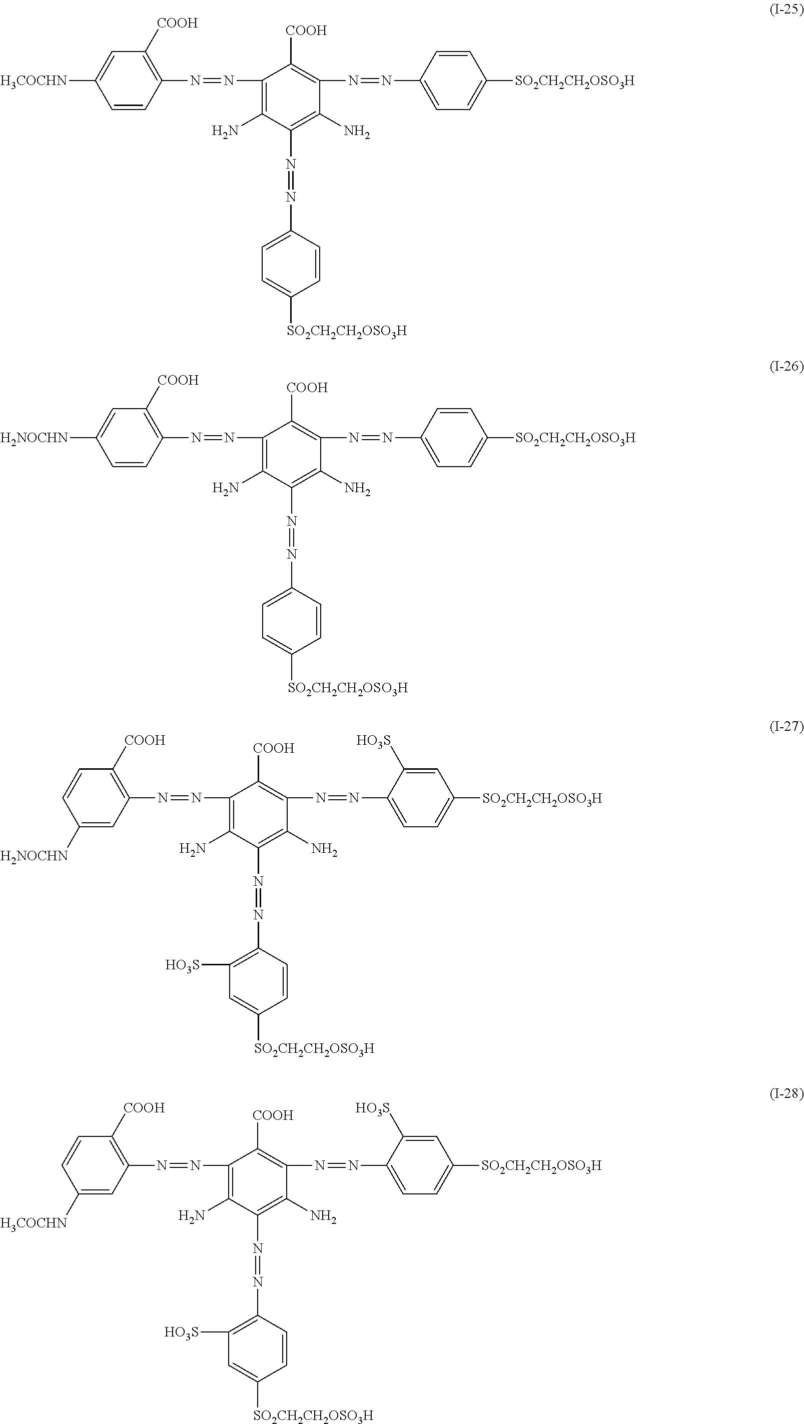

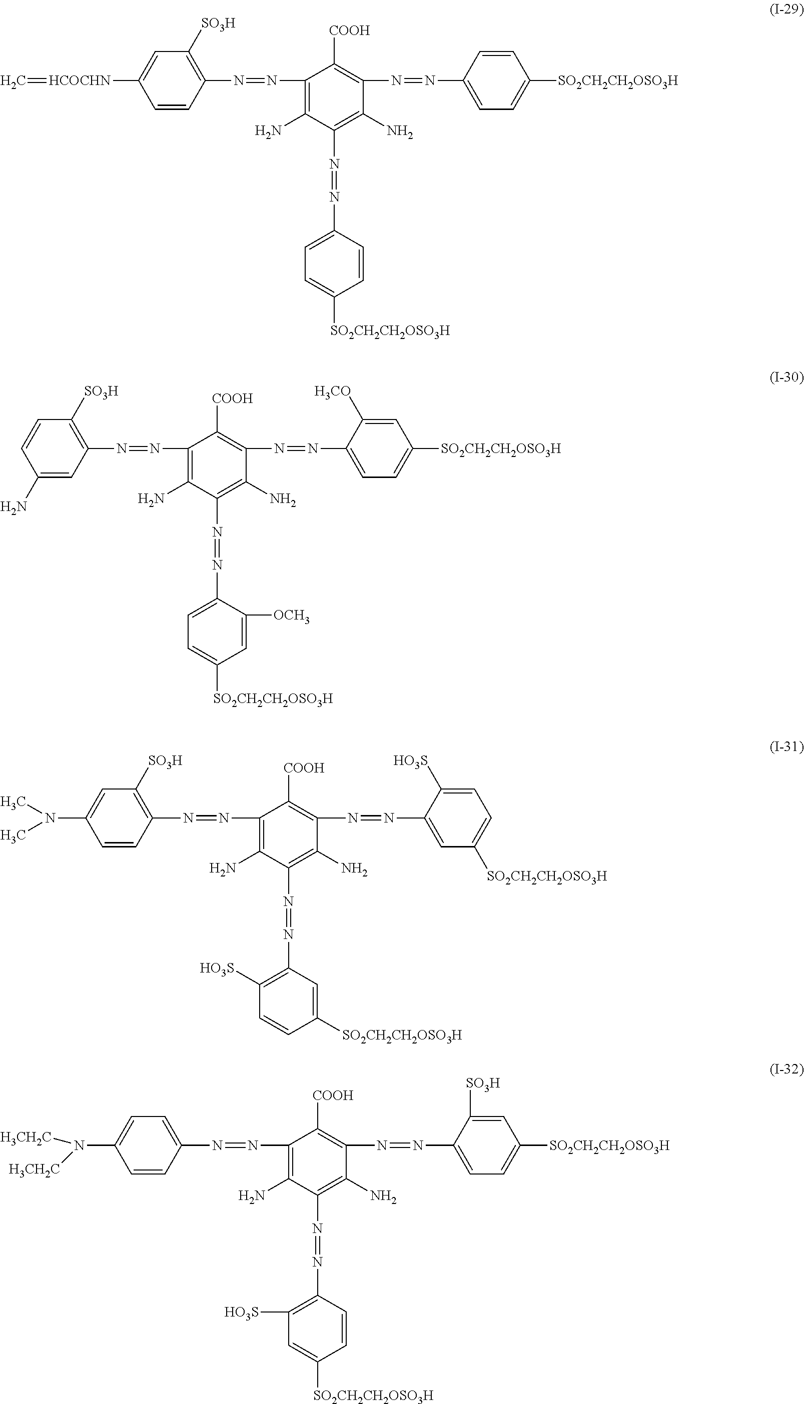

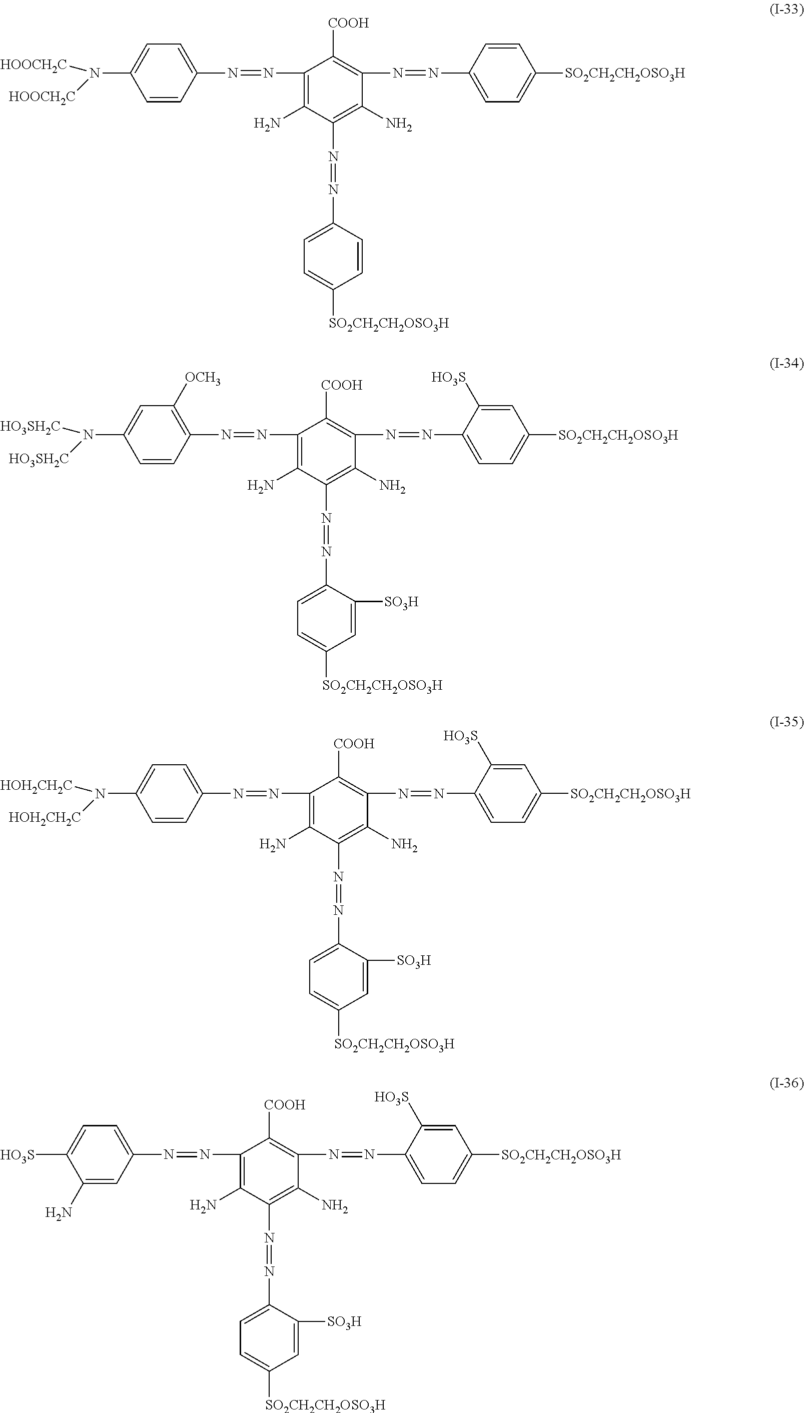

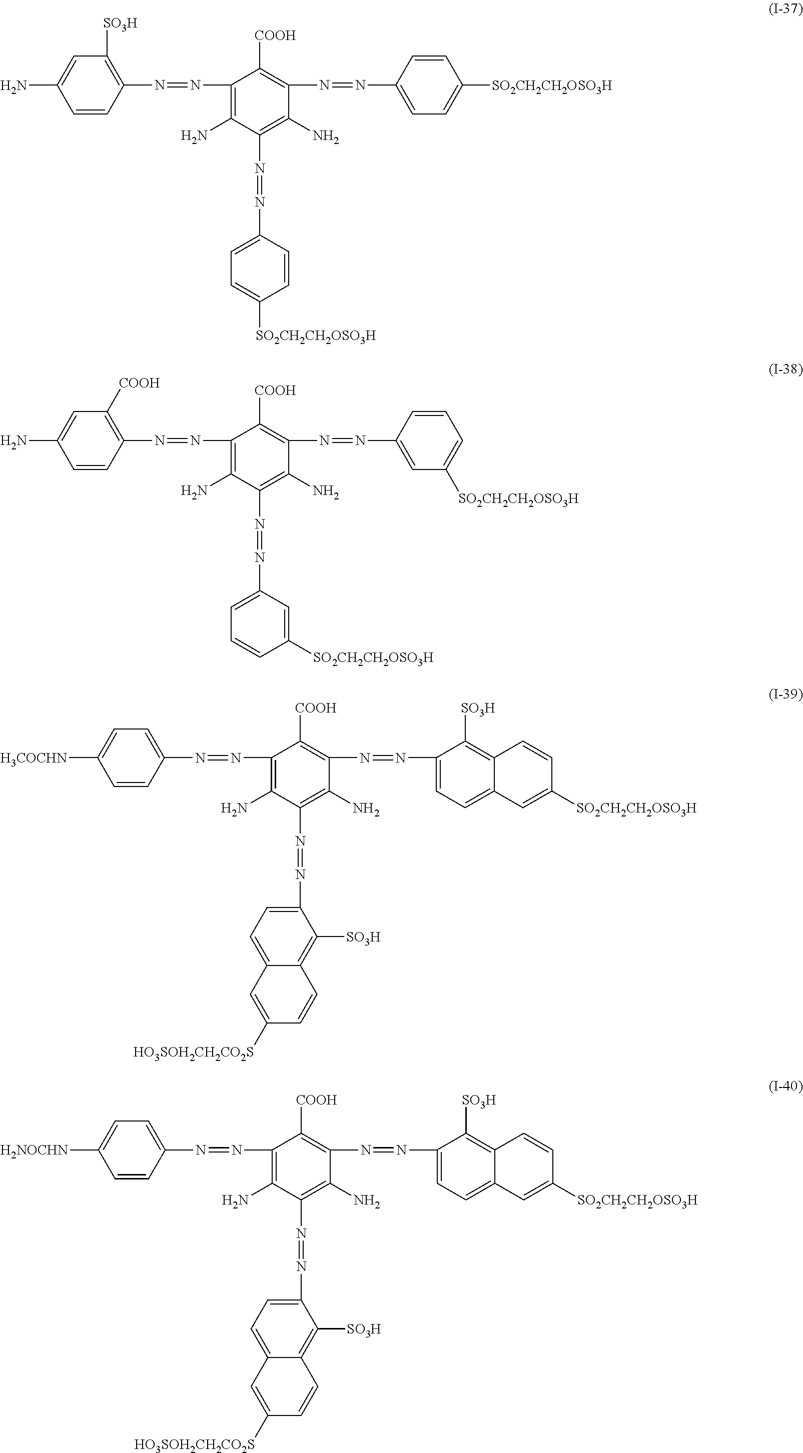

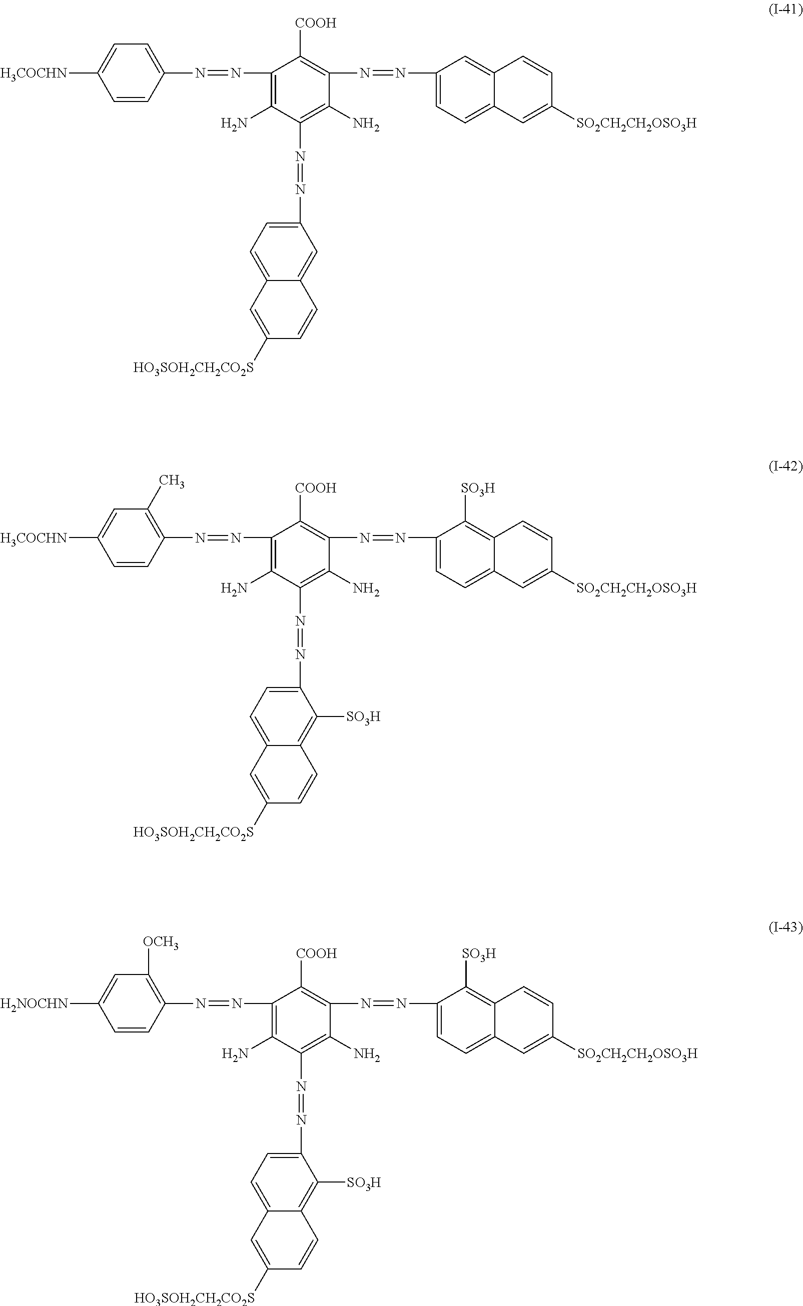

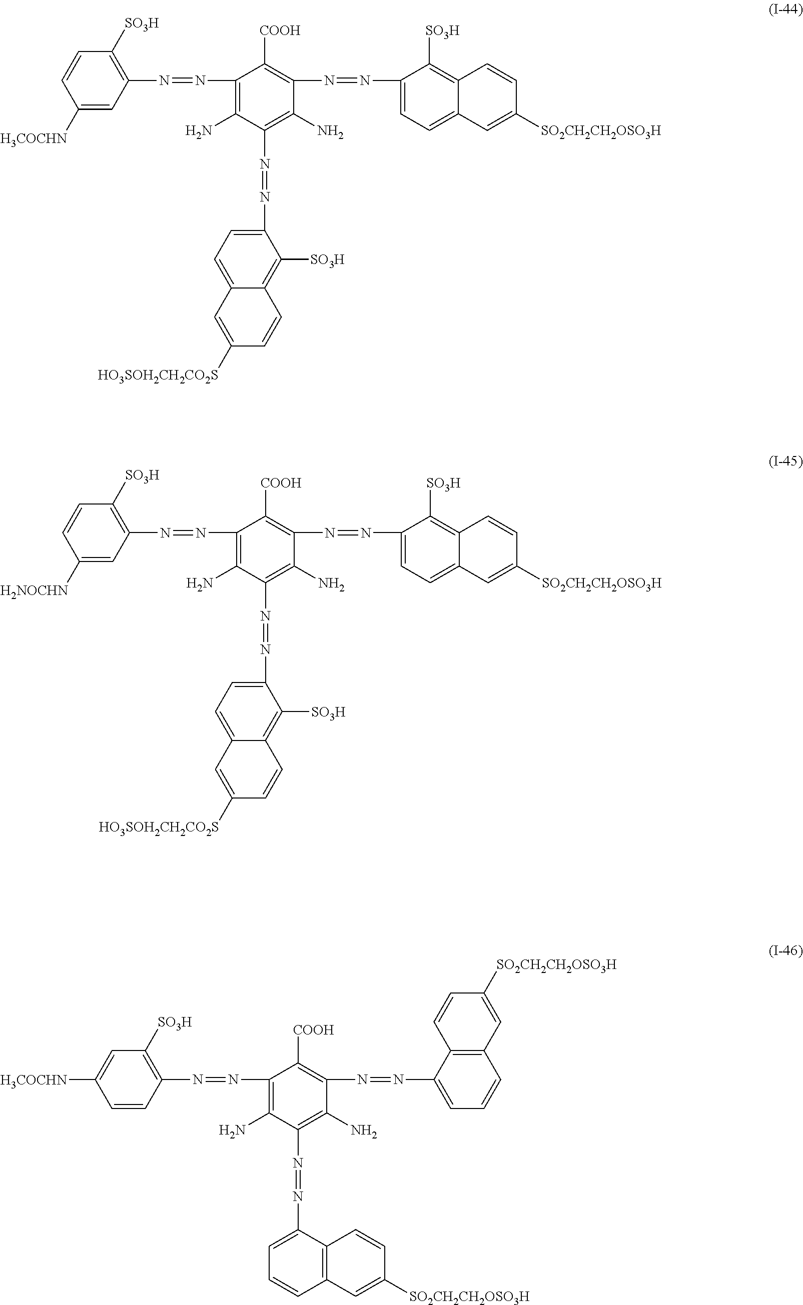

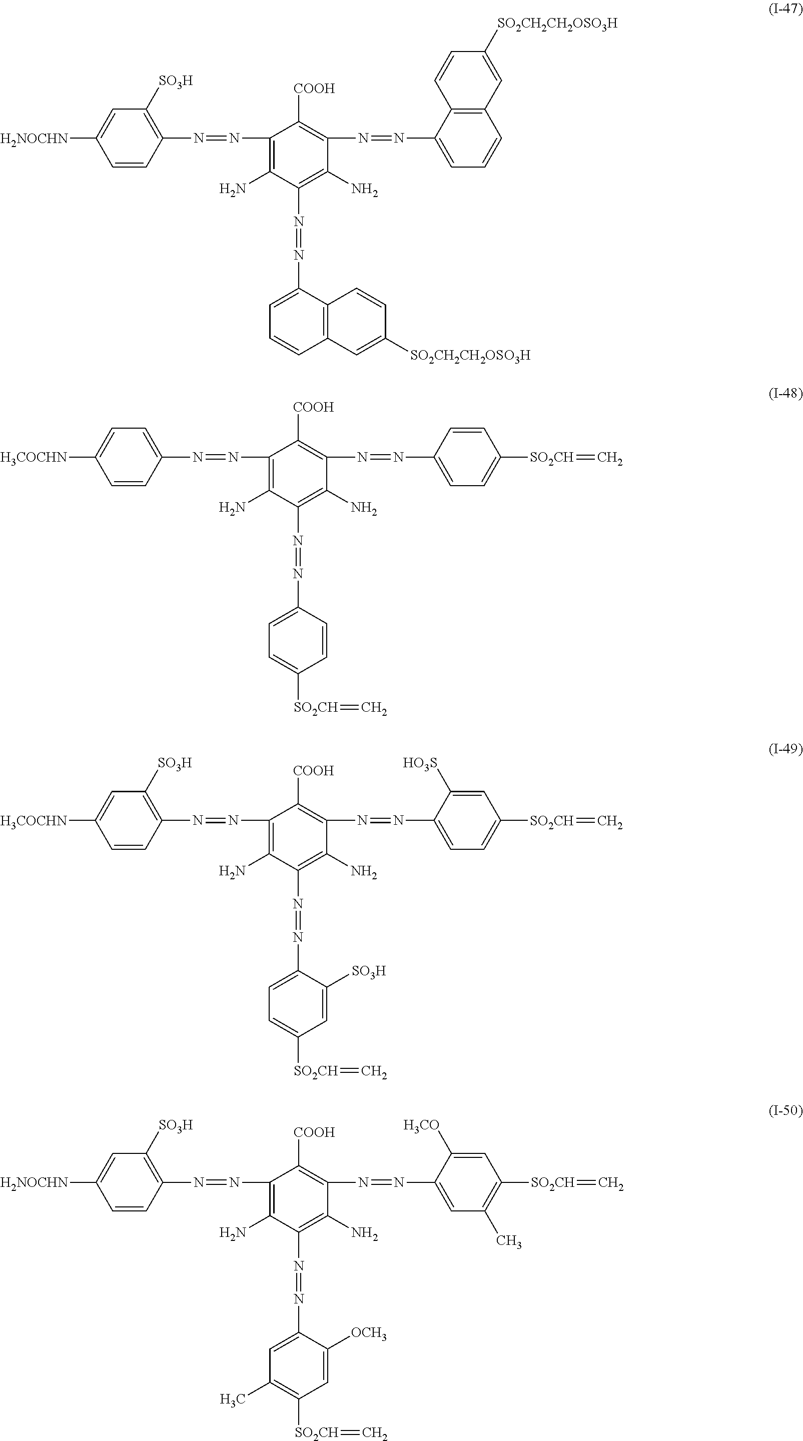

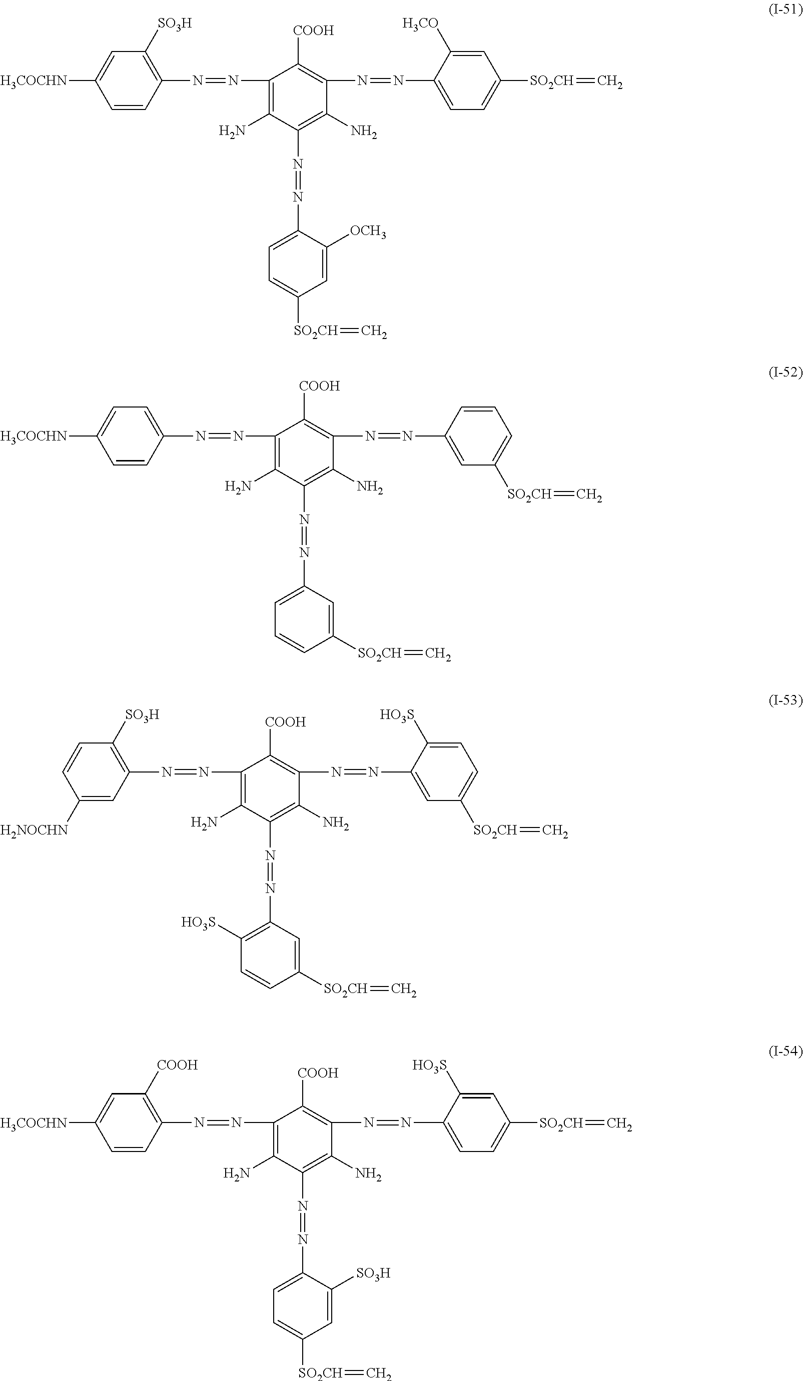

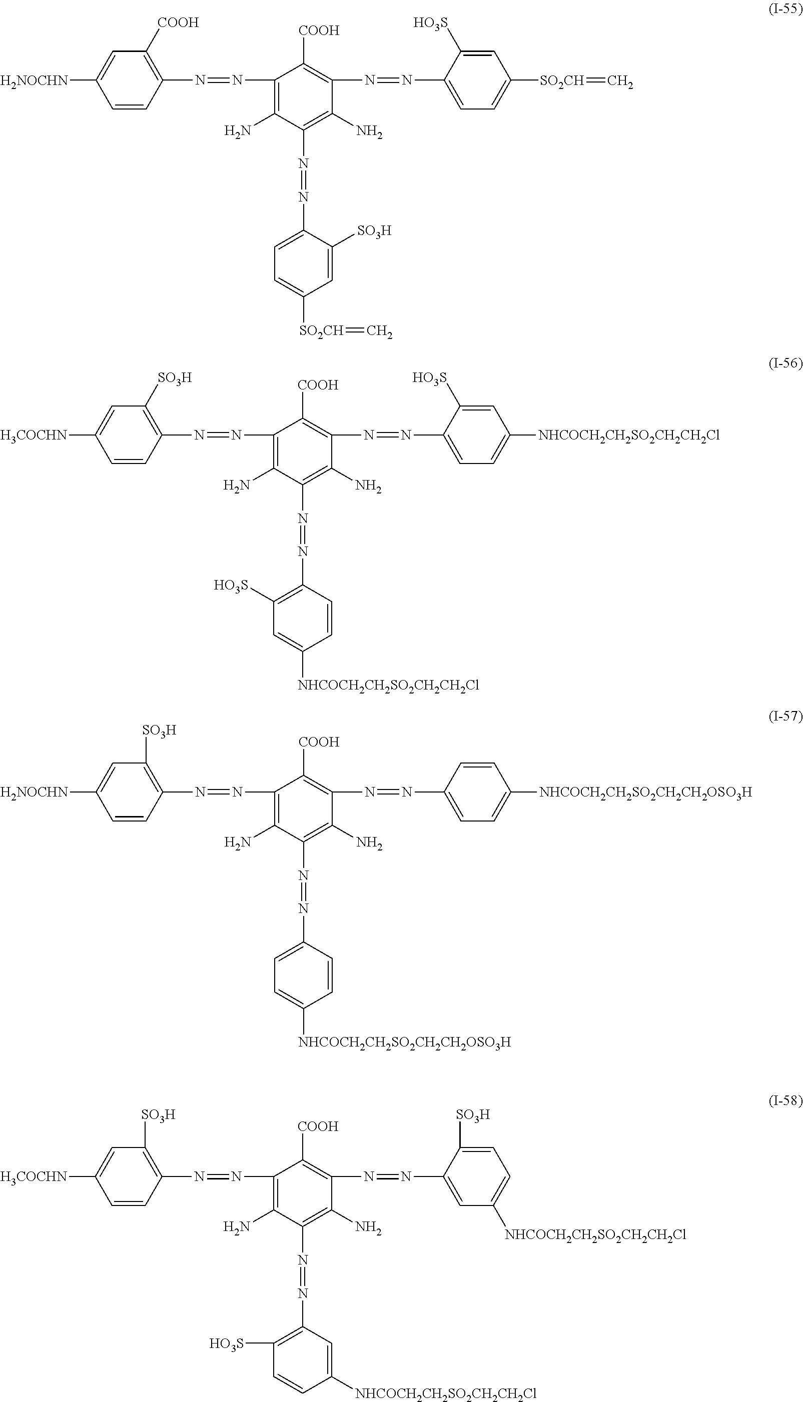

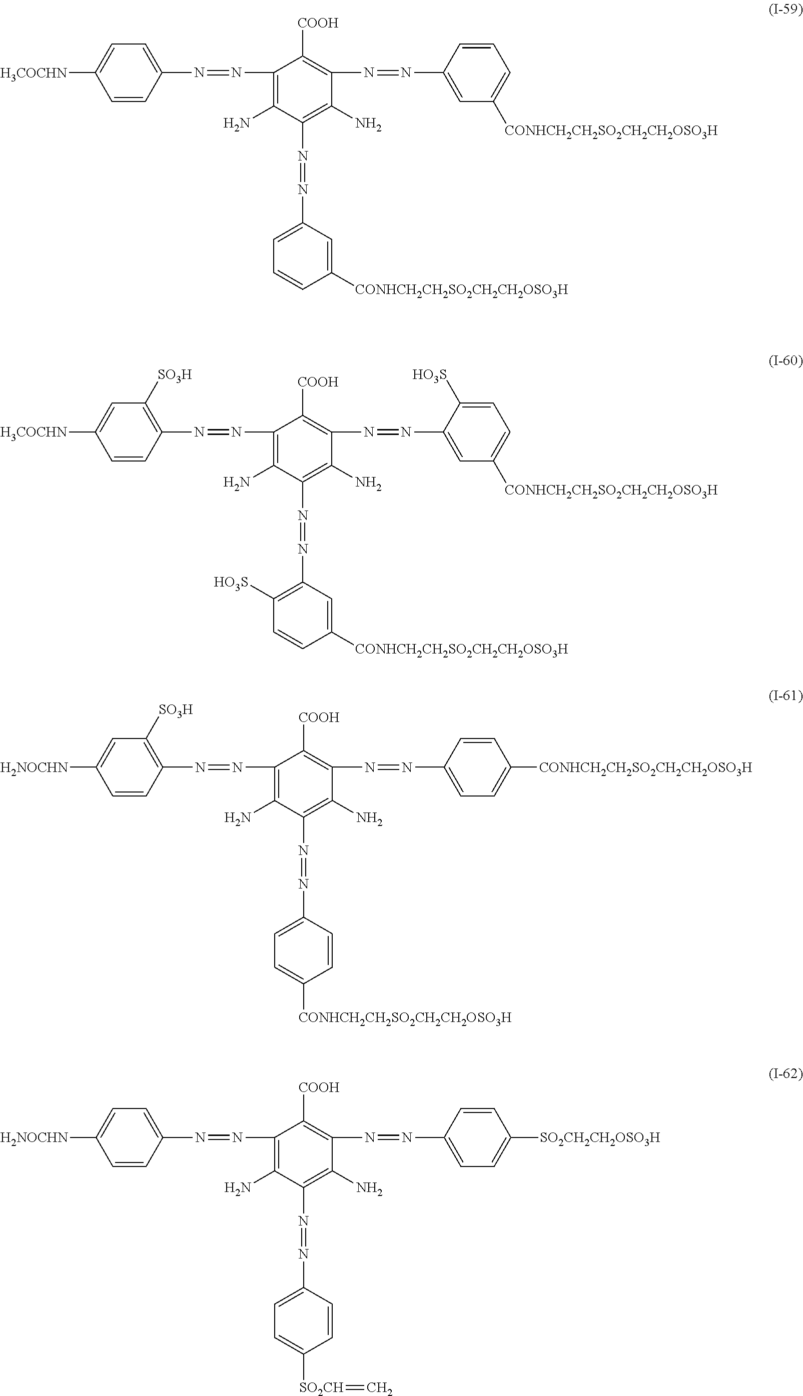

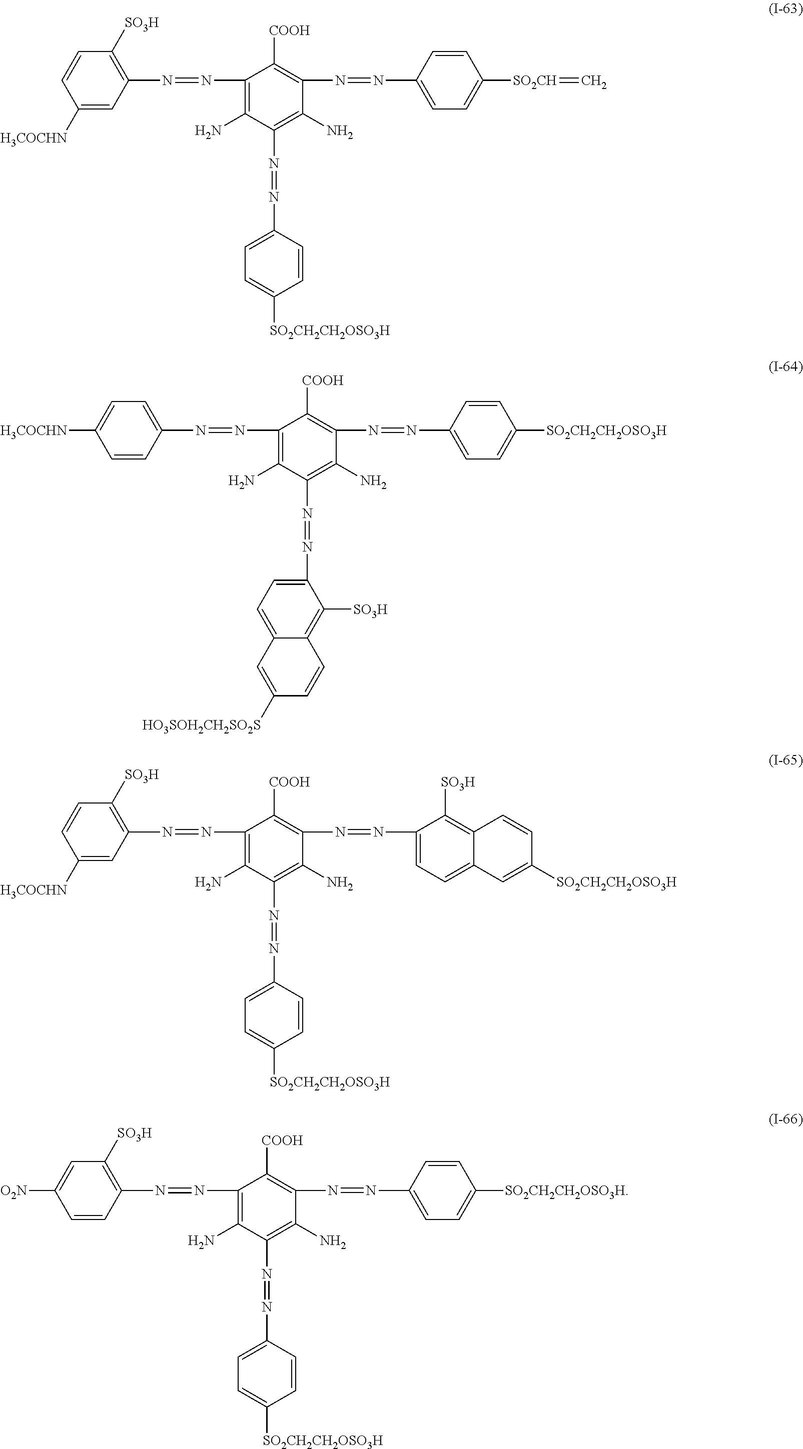

More preferably, the compound of formula (I) of the present invention is selected from the group consisting of compounds of formulae (I-1)˜(I-28) and (I-48)˜(I-55).

Even more preferably, the compound of formula (I) is selected from the group consisting of compounds of formulae (I-1), (I-2), (I-4), (I-5), (I-6) and (I-7).

The reactive dye compound of the present invention may be an alkali metal salt of the compound of formula (I), wherein the carboxyl groups and sulfonic acid groups in formula (I) are present in the form of alkali metal salts. Preferably, the alkali metal salt is sodium salt or potassium salt.

In the second aspect, the present invention provides a preparation method of the reactive dye compound, comprising:

### (1) Diazotization Reaction

according to needs, the aromatic amine compounds of formulae (IIa), (IIb) and/or (IIc) are subjected to diazotization reaction, respectively, thereby obtaining corresponding diazonium salts;

### (2) Coupling Reaction

3,5-dihydroxybenzoic acid is added with water and beaten, and the resulting 3,5-dihydroxybenzoic acid solution is subjected to the first coupling reaction with the diazonium salt of the aromatic amine compound formula(II a)obtained in the step (1), then the first-coupling product is subjected to the second coupling reaction with the diazonium salt of the aromatic amine compound formula (IIb) or (IIc), next, the second-coupling product is subjected to the third coupling reaction with the diazonium salt of the aromatic amine compound formula (IIb) or (IIc), thereby obtaining the reactive dye compound;

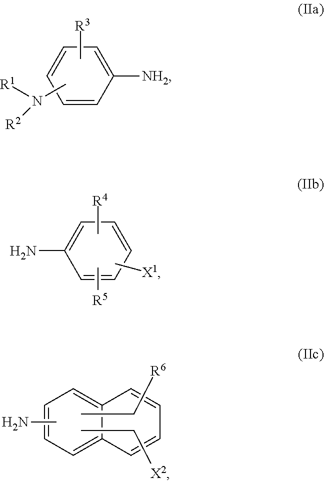

each substituent of formulae (IIa)˜(IIc) is the same as defined in formula (I).

Preferably, the specific synthesis steps of the reactive dye compound are specifically as follows:

### (1) Diazotization Reaction

according to needs, the aromatic amine compounds of formulae (IIa), (IIb) and/or (IIc) are each beaten with ice water for 1 to 2 hours; after the beating, a certain amount of hydrochloric acid is added, and then a sodium nitrite solution is added within 20-30 min, the diazotization reaction is carried out by controlling pH at between 0.5 and 3.0 (preferably between 0.5 and 2.0) and temperature T at between 0° C. and 30° C. (preferably at between 0° C. and 20° C.), the end point of the reaction is detected with an ethanol solution of 4-dimethylaminobenzaldehyde (that is, if no color change within 5 s, the end point is reached); after the diazotization, excess sodium nitrite is eliminated with sulfamic acid, and the diazonium salt solution of aromatic amine compound of the formula (IIa), (IIb) or (IIc) is obtained and stored for use; wherein the molar ratio of the aromatic amine compound of formula (IIa), (IIb) or (IIc) to hydrochloric acid and sodium nitrite is 1:(1-3):(1-1.1), preferably is 1:(1-1.8):(1-1.05);

### (2) Coupling Reaction

first, 3,5-diaminobenzoic acid is dissolved with water, the pH of the solution is controlled to be between 8.0 and 12.0, and the temperature of the solution is controlled to be between 15° C. and 25° C.; the dissolved 3,5-diaminobenzoic acid solution is added to the diazonium salt solution of the aromatic amine compound of formula (IIa) prepared in the above step (1), the pH is controlled to be between 2.0 and 6.0 with liquid alkali or baking soda, the temperature is controlled to be between 0° C. and 20° C., and the first coupling reaction is carried out, the first reaction solution is tested with H acid test solution, if the bleed circle is colorless, it means that the diazonium has been reacted completely to the end point, thereby obtaining coupling product 1;

second, the diazonium salt solution of formula (IIb) or (IIc) prepared in step (1) is added to coupling product 1, the pH is controlled to be between 5.0 and 8.0 with liquid alkali or baking soda, the temperature is controlled to be between 0° C. and 20° C., and the second coupling reaction is carried out, the second reaction solution is tested with H acid test solution, if the bleed circle is colorless, it means that the diazonium has been reacted completely to the end point, thereby obtaining coupling product 2;

third, the diazonium salt solution of formula (IIb) or (IIc) prepared in step (1) is added to coupling product 2, the pH is controlled to be between 5.0 and 8.0 with liquid alkali or baking soda, the temperature is controlled to be between 0° C. and 20° C., and the third coupling reaction is carried out, the third reaction solution is tested with H acid test solution, if the bleed circle is colorless, it means that the diazonium has been reacted completely to the end point, thereby obtaining the reactive dye compound;

wherein the molar ratio of the aromatic amine compounds of formula (IIa), (IIb) or (IIc) in every coupling to 3,5-diaminobenzoic acid is controlled to be (0.95-1.2):1, preferably (0.98-1.08):1;

Further, if both D¹ and D² are the group of formula (a) or (b), the second coupling reaction and the third coupling reaction can be merged into one coupling reaction, that is, the diazonium salt solution of the aromatic amine compound of formula (IIb) or (IIc) prepared in step (1) is added to coupling product 1, the pH is controlled to be between 5.0 and 8.0 with liquid alkali or baking soda, the temperature is controlled to be between 0° C. and 20° C., and the second coupling reaction is carried out, the second reaction solution is tested with H acid test solution, if the bleed circle is colorless, it means that the diazonium has been reacted completely to the end point, thereby obtaining the reactive dye compound of formula (I) of the present invention; wherein, the molar ratio of the aromatic amine compound of formula (IIb) or (IIc) to 3,5-diaminobenzoic acid is controlled to be (1.9-2.4):1, preferably (1.96-2.16):1.

The reactive dye compound of the present invention, in the preparation process, also allows the co-existence of by-products in an amount of not more than 30%, which may be used in the processing of commercial dyes without isolation, and the by-products include but are not limited to the compounds of the following formulae or mixtures thereof:

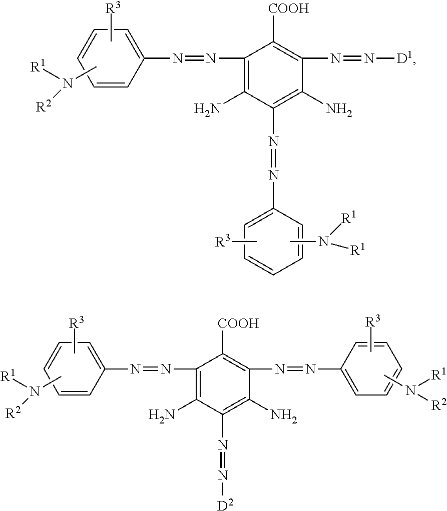

each substituent of the above by-products has the same definition as that of the above formula (I).

In the actual synthesis process, the reactive dye compound of the present invention is usually prepared and isolated in the form of an alkali metal salt (such as a sodium salt or a potassium salt), and also used in the form of its salt for dyeing, which is well known to those skilled in the art, that is, the carboxyl and the sulfo groups of formula (I), may be present in the form of alkali metal salts of carboxylic acid(such as sodium carboxylate) and sulfonic acid(such as sodium sulfonate).

The reactive dye compound of the present invention may be present in the form of powder, granule, an aqueous solution or a synthetic solution. Separation of the reactive dye compound of the present invention from the synthetic solution can be carried out by a generally known method, for example, the dye is salted out and filtered from a reaction medium with an electrolyte salt (such as sodium chloride or potassium chloride), or the mixture is evaporated and spray dried. Hence, the dye compounds generally contain the conventional electrolyte salt(s) (such as sodium chloride, sodium sulfate, etc.) commonly appearing in reactive dyes.

In the third aspect, the present invention provides an application of the reactive dye compound in printing and dyeing of cellulosic fibers, polyamide fibers or their fabrics.

It is well known in the art that where Y¹˜Y³ in the reactive dye compound of the present invention are —C₂H₄OSO₃H or —CH₂CH₂Cl, in the common dyeing application of reactive dyes, β-hydroxyethylsulfonyl sulfate (—SO₂C₂H₄OSO₃H) or β-chloroethyl sulfone (—SO₂C₂H₄Cl) is subjected to elimination reaction to generate a vinyl sulfone group (—SO₂CH═CH₂) in an alkaline medium, then subjected to nucleophilic addition reaction with a cellulose fiber to form a covalent bond.

When sold as a commodity or used directly, the reactive dye compound of the present invention can be without an auxiliary, and can also be added with an auxiliary commonly used in commercial dyes, such as a cosolvent, a dispersant, an alkali-resistant auxiliary, a dustproof agent, a surfactant, a buffer, and an accelerant. Therefore, the present invention also provides a reactive dye product comprising the dye compound. Preferably, the reactive dye product contains the reactive dye compound and an auxiliary, wherein the weight of the auxiliary does not exceed 45%, preferably 40% of the weight of the reactive dye compound. The auxiliary is preferably one or more selected from the group consisting of the following compounds: a naphthalene sulfonic acid/formaldehyde condensation product (NNO), a methylnaphthalenesulfonic acid/formaldehyde condensation product (dispersant MF), a diffusing agent CNF (benzylnaphthalenesulfonate/formaldehyde condensation product), Yuanming powder (industrial sodium sulfate), lignosulfonate, sodium acetate, sodium hydrogencarbonate, sodium citrate, sodium dihydrogen phosphate, disodium hydrogen phosphate, a thickener, and the like. All the auxiliaries are commercially available conventional products.

The reactive dye compound and the reactive dye product of the present invention is suitable for dyeing and printing of cellulosic fibers, polyamide fibers or their fabrics. Wherein, the cellulose fibers are preferably cotton fibers or regenerated fibers, and of course may include other vegetable fibers such as hemp fibers or fabrics thereof; the polyamide fibers preferably include animal fiber materials including skin, wool or silk, and synthetic fiber materials such as nylon 6 and nylon 66. When the above-mentioned fiber materials are dyed and printed by using the reactive dye compound or the reactive dye product of the present invention, it can be carried out according to known reactive dye dyeing and printing methods, such as a commonly used reactive dye dip dyeing method and pad dyeing method, and the dip dyeing method is a method of immersing a fabric into a dyeing solution to gradually dye the fabric, which usually needs to go through the processes of dyeing-fixing-washing-soaping-washing-dehydration-drying and so on.

The pad dyeing method is a method of firstly immersing the fabric into a dyeing solution, then passing the fabric through a roll, uniformly rolling the dyeing solution into the interior of the fabric, and then treating the fabric by steaming, hot-melting or other treatments, which usually needs to go through the processes of padding with a dye solution-drying-(padding with a fixing solution)-steaming or curing-washing-soaping-washing-drying and so on.

Generally, due to different requirements for the dyed color of the fabrics, the usage amount of dyes is different. When dyed by dip dyeing, the dyeing depth (owf) is generally between 0.1% and 10% (which means the weight of the dye accounts for 0.1%˜10% of the weight of the fabric), the bath ratio is 1: 2 to 1:60 (the bath ratio is defined as the weight ratio of the fabric to the dyeing solution, and preferably is 1:10 to 1:30), the initial dyeing temperature is controlled to be between 30° C. and 60° C., the dyeing time is 10 minutes to 30 minutes, the soaping temperature is 85° C. to 95° C., the soaping time is 10 minutes to 15 minutes, the fixing temperature is 60° C. to 100° C., the fixing time is 10 minutes to 50 minutes, and the fixing pH is 9 to 11. When dyed by the pad dyeing method, the pickup of cellulose fiber is generally 60% to 80%, the steaming temperature is 100° C. to 103° C., and the steaming time is 1 minute to 3 minutes. In padding methods, cold pad-batch dyeing method is widely used, in which a dye and an alkaline substance are introduced into a pad dyeing machine, batched onto a roll and the roll which is covered is turned slowly for 2 hours to 30 hours at room temperature for fixation, and then thoroughly rinsed.

The advantages of the present invention are embodied in that the reactive dye compound has a novel structure, good washing fastness and rubbing fastness, and good fiber-bonding stability, and are suitable for dyeing and printing of fibers such as cotton, rayon, silk, viscose, and wool.

### BRIEF DESCRIPTION OF THE DRAWINGS

FIG. 1 is the mass spectrum of the compound (I-1) obtained in example 1.

FIG. 2 is the mass spectrum of the chromophore (A) obtained in example 1.

### SPECIFIC EMBODIMENTS

The present invention will be further described in conjunction with the specific examples, but the scope of protection of the present invention is not limited thereto:

The dye compounds used in the examples of the present invention were prepared and separated in the form of their sodium salt in the actual synthesis process, and are also used for dyeing in the form of their sodium salt, but for the convenience of writing, all the chemical formulae of the dye compounds in the examples are expressed in the form of their free acid, and their substantial dyeing properties are equivalent to the form of sodium salt.

### EXAMPLE 1

### (1) Diazotization

23.0 g (0.1 mol) of 4-(acetylamino)-2-amino-benzenesulfonic acid were added into 100 g of water and 100 g of ice, beaten for about 1 h, added with 20 g of 31% hydrochloric acid (containing 0 17 mol of HCl), and added with 24g of a 30% sodium nitrite solution (containing 0.104 mol of sodium nitrite) within 20 min to 30 min. The diazotization reaction was carried out for 1˜2 hours by controlling pH at between 0.5 and 2.0 and temperature T at between 0° C. and 20° C., and the end point of the reaction was detected with an ethanol solution of 4-dimethylaminobenzaldehyde (ie, if no color change within 5 s, the end point was reached). After the diazotization, excess sodium nitrite was eliminated with sulfamic acid, and the diazonium solution of 4-(acetylamino)-2-amino-benzenesulfonic acid was obtained and stored for use.

56.2 g (0.2 mol of para-ester (p-β-hydroxyethylsulfone sulfate aniline) were added into 200 g of water and 200 g of ice, beaten for about 1 h, added with 35 g of 31% hydrochloric acid (containing 0.3 mol of HCl), and added with 48 g of a 30% sodium nitrite solution (containing 0.208 mol of sodium nitrite) within 20 min to 30 min. The diazotization reaction was carried out for 1˜2 hours by controlling pH at between 0.5 and 2.0 and temperature T at between 0° C. and 20° C., and the end point of the reaction was detected with an ethanol solution of 4-dimethylaminobenzaldehyde (ie, if no color change within 5 s, the end point was reached). After the diazotization, excess sodium nitrite was eliminated with sulfamic acid, and the diazonium solution of the para-ester was obtained and stored for use.

### (2) Coupling Reaction

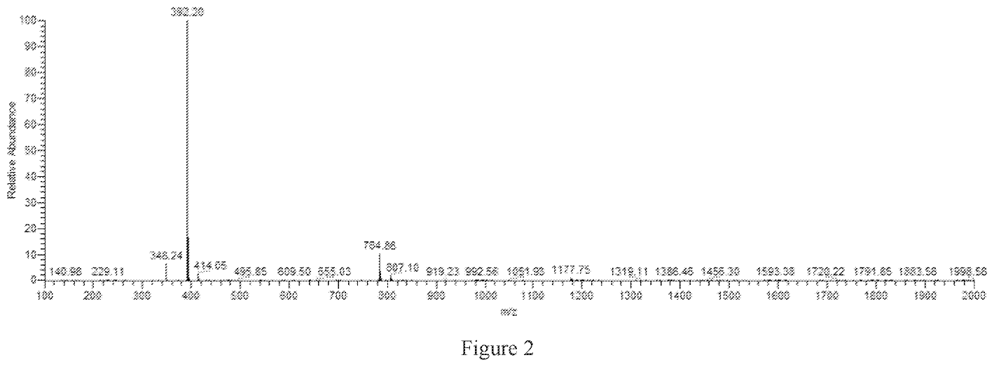

15.2 g (0.1 mol) of 3,5-dihydroxybenzoic acid were added to 200 g of water for beating, the pH of the solution was controlled to be between 8.0 and 9.0 with soda ash, and the temperature of the solution was controlled to be between 20° C. and 25° C. After the beating, the diazonium solution of 0.1 mol 4-(acetylamino)-2-amino-benzenesulfonic acid obtained in step (1) was added to the 3,5-dihydroxybenzoic acid solution. The pH was controlled to be between 5 and 5.5 with 30% liquid alkali, the temperature was controlled to be between 5° C. and 10° C., the reaction was carried out for 0.5˜2 h, and when the content of the free 3,5-dihydroxybenzoic acid was detected to be below 3% by HPLC, the reaction reached the end point, thereby obtaining chromophore of the following formula (A) whose mass spectrum is shown in FIG. 2.

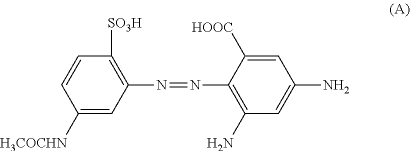

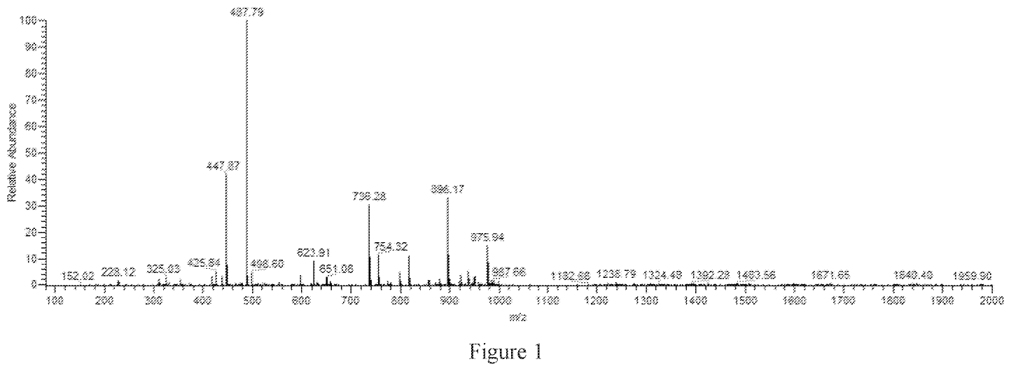

The diazonium solution of the para-ester obtained in step (1) was added to the chromophore of formula (A), the pH was controlled to be between 5 and 5.5 with 30% liquid alkali, and the temperature T was controlled to be between 5° C. and 10° C., the coupling reaction was further carried out for 0.5 h to 10 h. The reaction solution was tested with H acid test solution, if the bleed circle was colorless, it meant that the diazonium had been reacted completely to the end point, thereby obtaining an orange reactive dye compound (I-1) whose λmax is 420 nm in water. And the mass spectrum of the compound (I-1) is shown in FIG. 1.

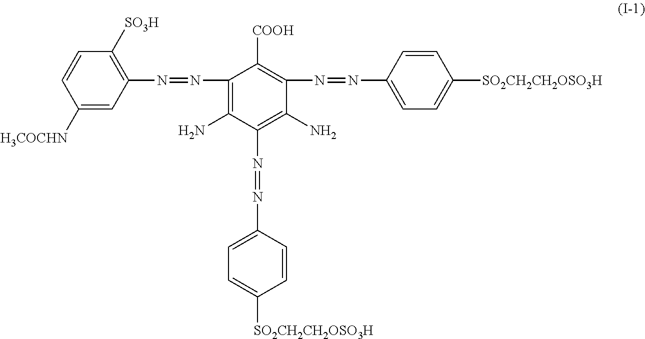

### EXAMPLE 2˜66

Referring to the preparation method of the azo dye described in example 1, the dye compounds of the structures shown in the following table 1 were respectively obtained by stepwise diazotization and coupling reactions using raw materials of intermediates well known in the art.

TABLE 1

| | | λmax |
|---|---|---|
| Examples | Reactive dye compounds | (nm) |
| 2 | 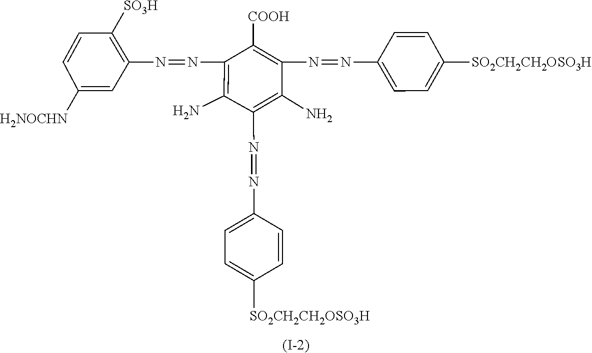 | 420 |
| 3 | 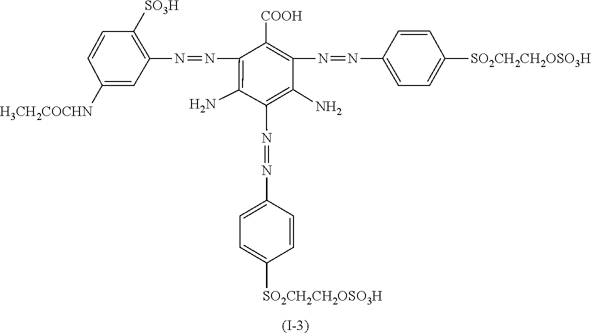 | 420 |
| 4 | 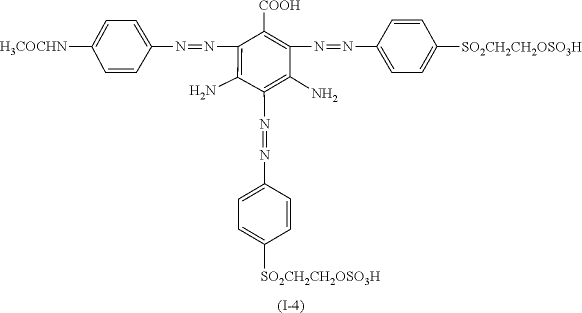 | 412 |
| 5 | 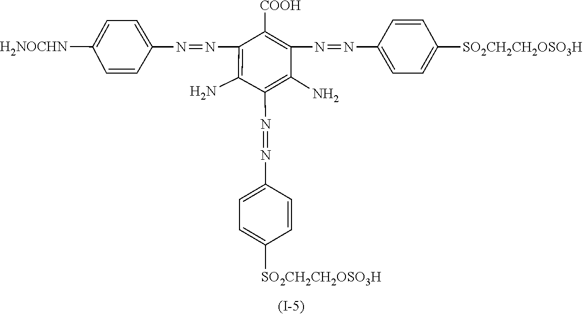 | 412 |
| 6 | 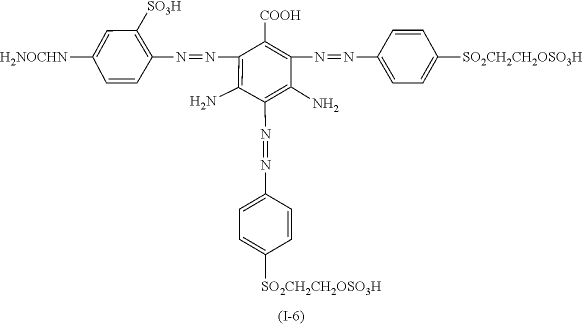 | 420 |
| 7 | 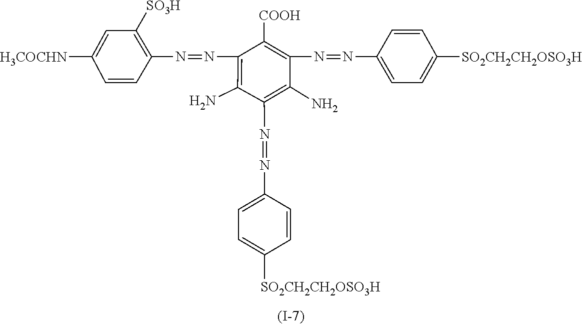 | 420 |
| 8 | 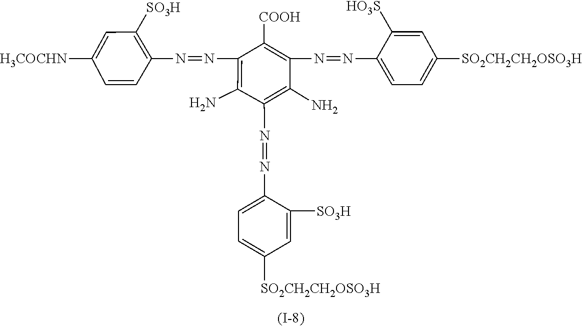 | 425 |
| 9 | 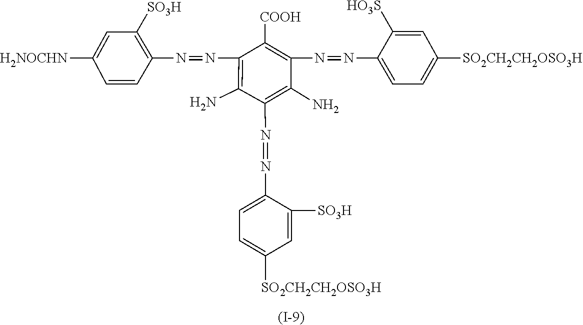 | 425 |
| 10 | 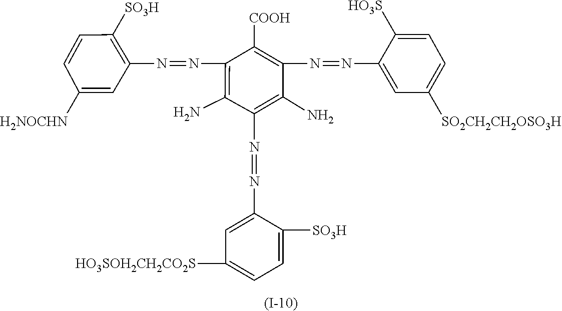 | 425 |
| 11 | 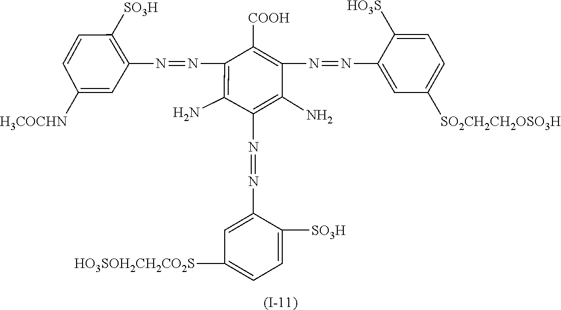 | 425 |
| 12 | 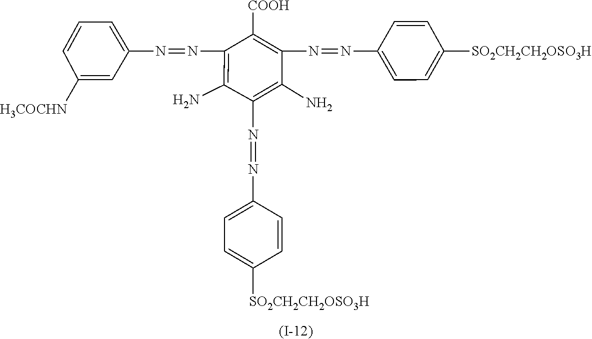 | 415 |
| 13 | 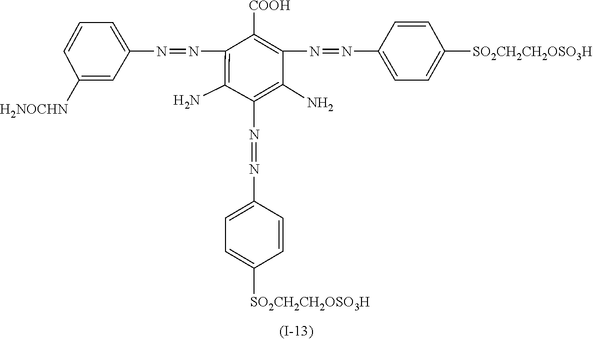 | 415 |
| 14 | 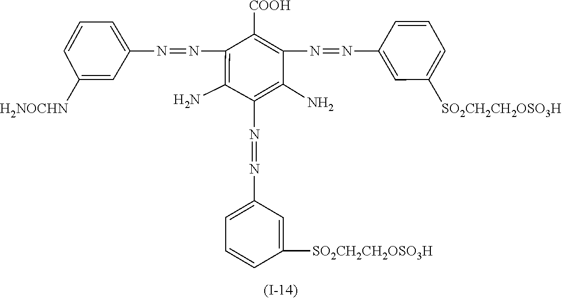 | 415 |
| 15 | 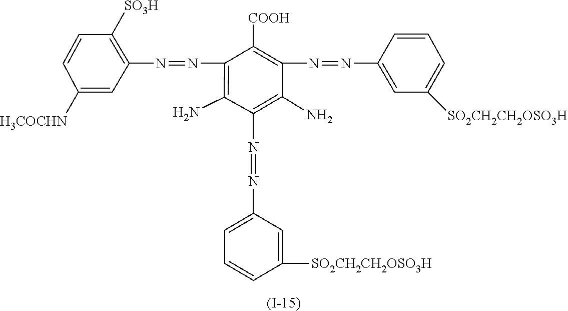 | 420 |
| 16 | 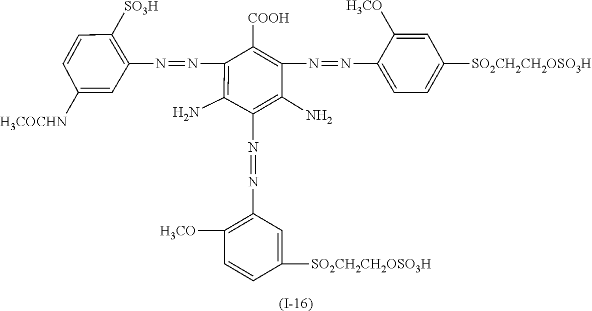 | 415 |
| 17 | 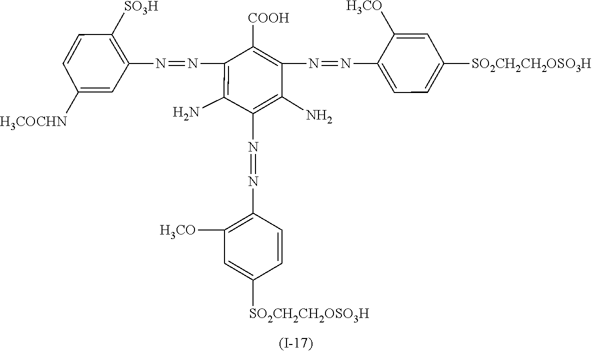 | 415 |
| 18 | 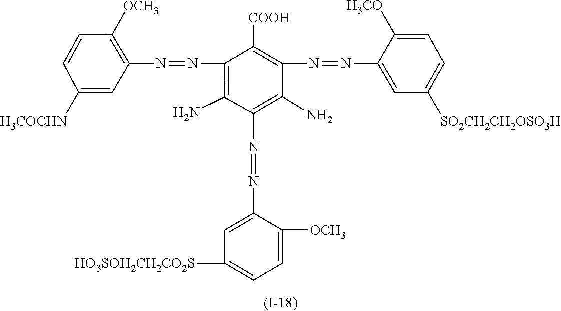 | 410 |
| 19 | 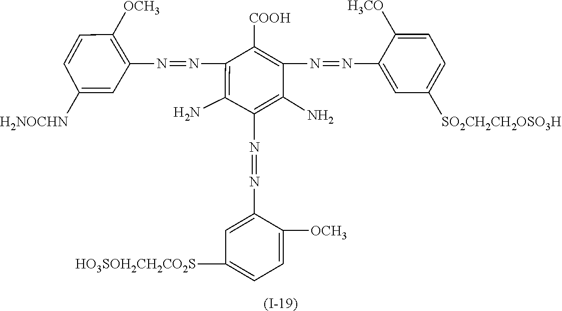 | 410 |
| 20 | 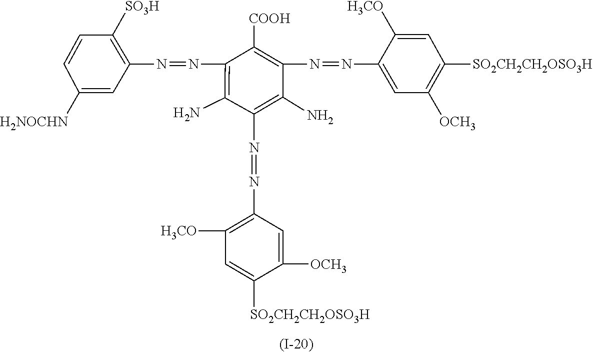 | 415 |
| 21 | 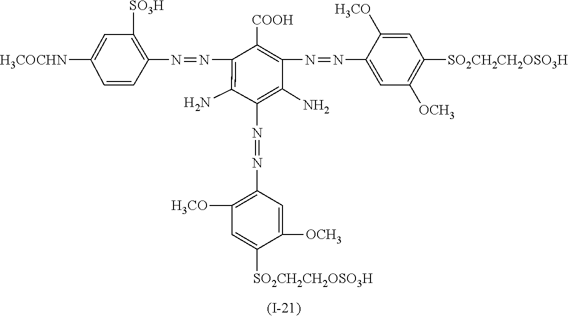 | 415 |
| 22 | 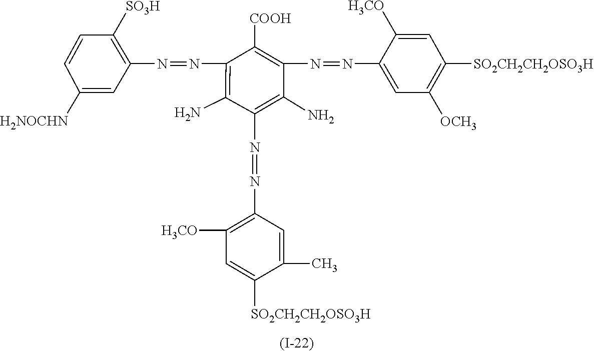 | 415 |
| 23 | 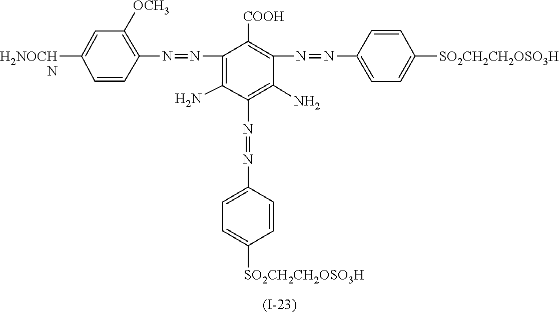 | 410 |
| 24 | 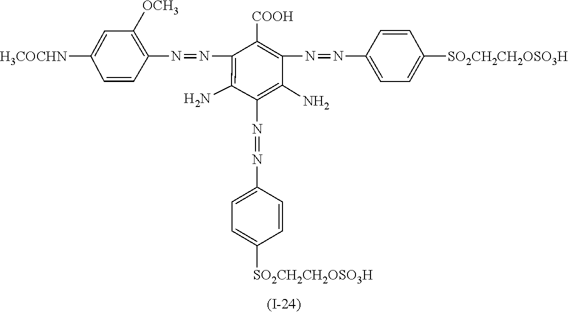 | 410 |
| 25 | 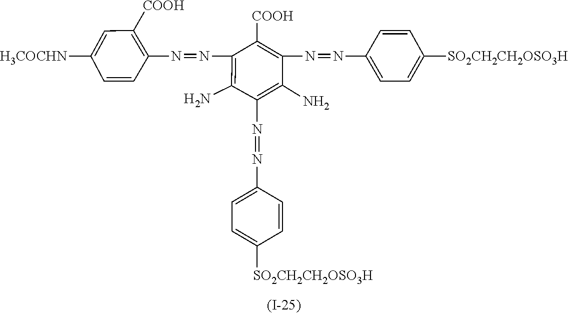 | 415 |
| 26 | 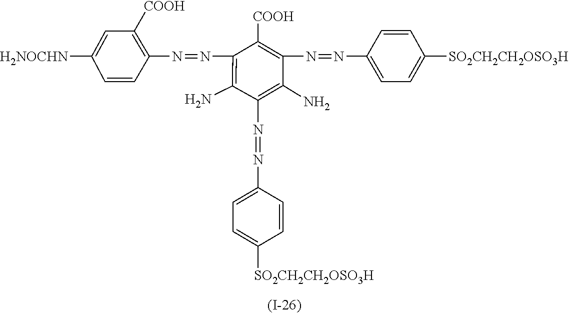 | 415 |
| 27 | 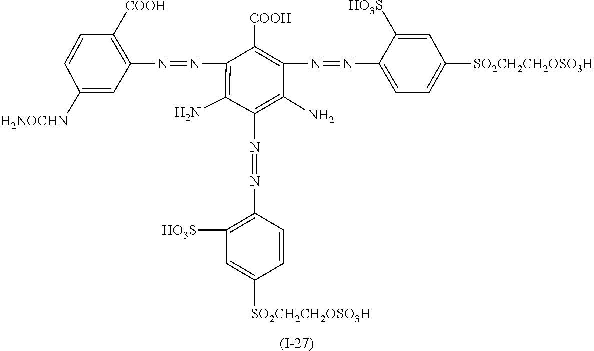 | 425 |
| 28 | 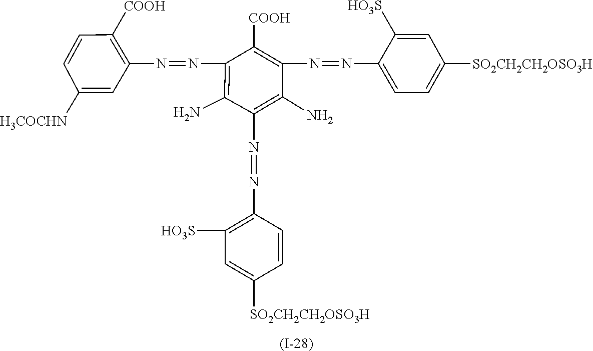 | 425 |
| 29 | 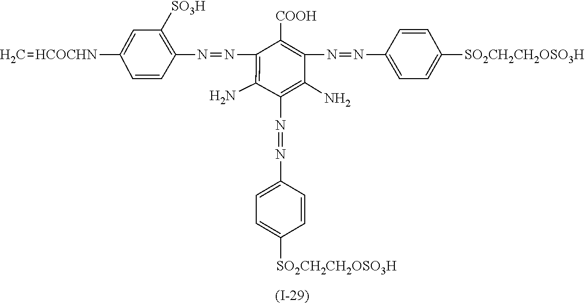 | 420 |
| 30 | 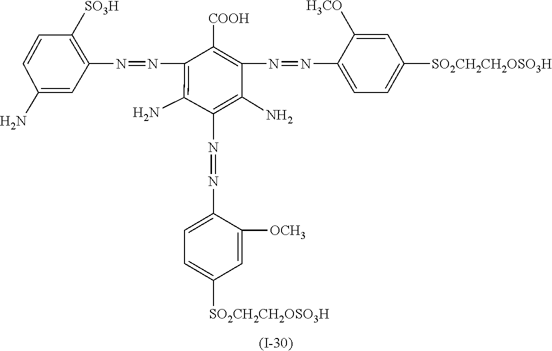 | 415 |
| 31 | 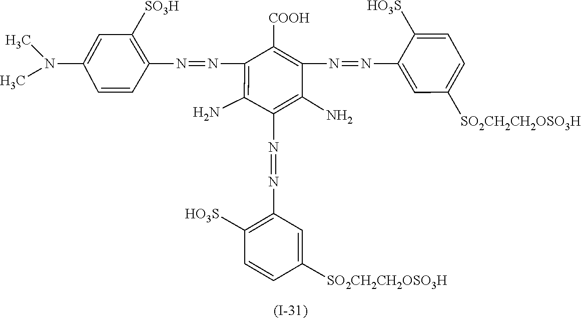 | 410 |
| 32 | 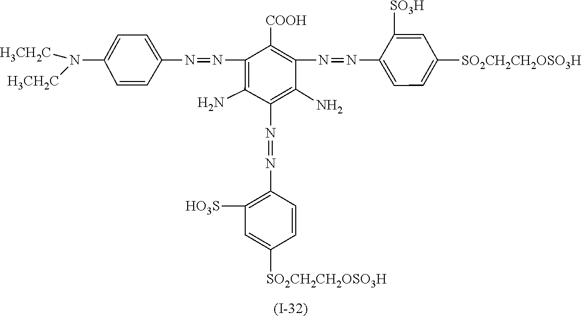 | 410 |
| 33 | 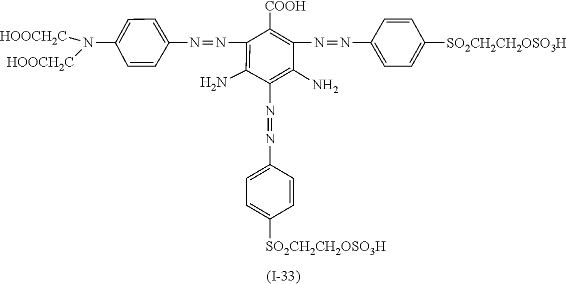 | 410 |
| 34 | 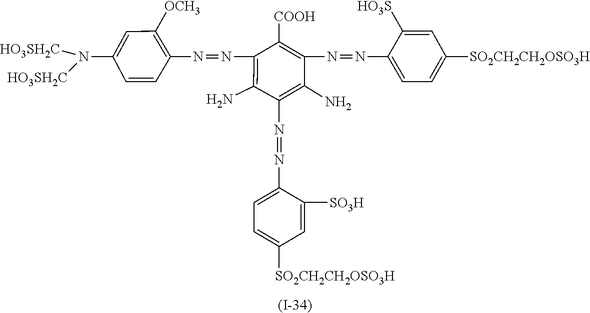 | 415 |
| 35 | 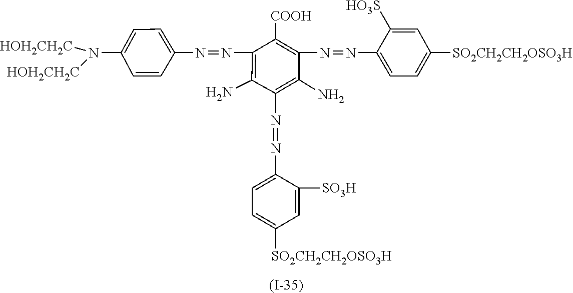 | 410 |
| 36 | 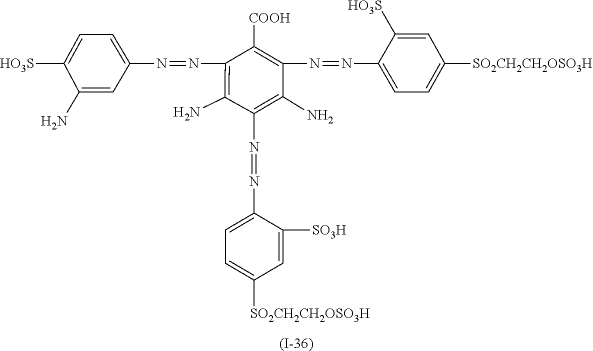 | 418 |
| 37 | 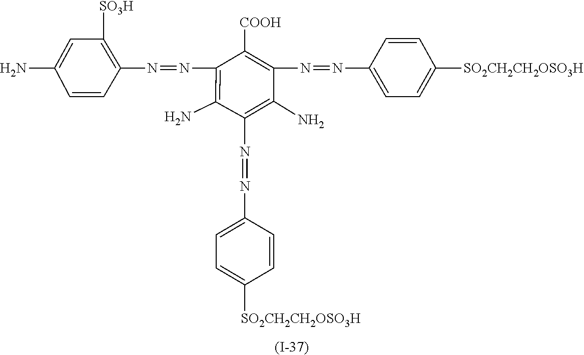 | 418 |
| 38 | 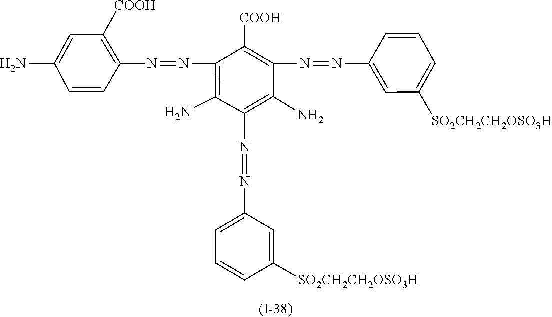 | 418 |
| 39 | 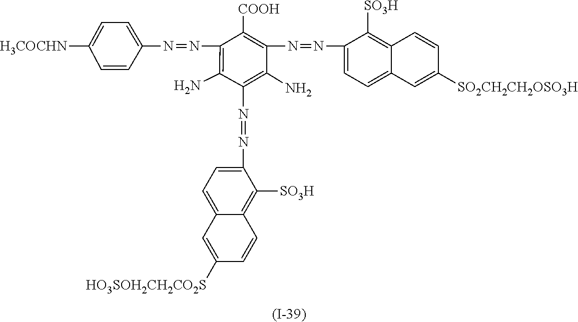 | 435 |
| 40 | 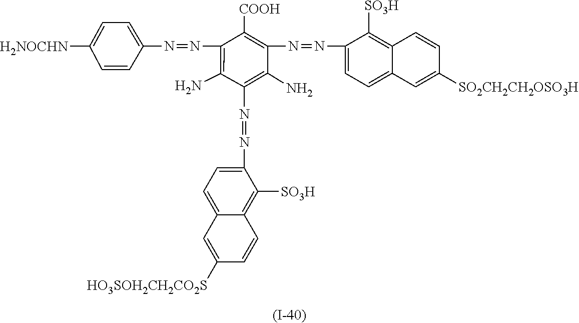 | 435 |
| 41 | 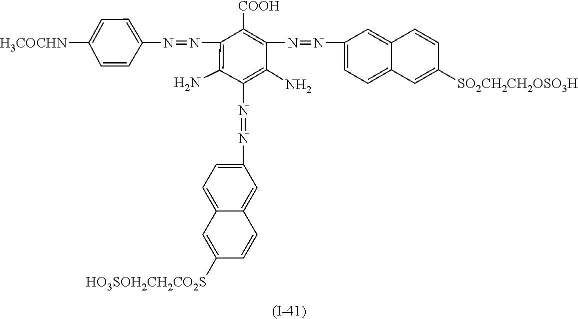 | 430 |
| 42 | 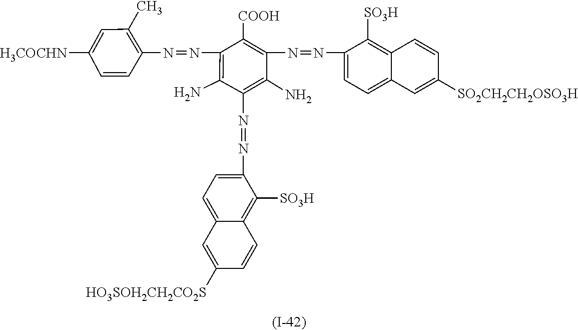 | 435 |
| 43 | 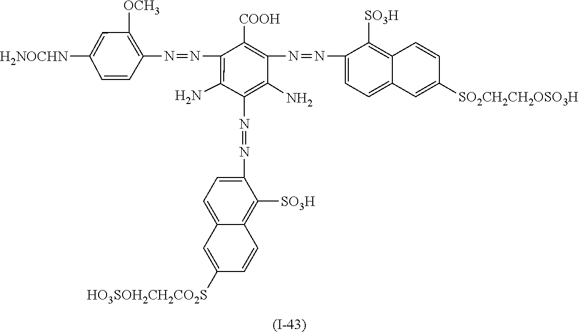 | 435 |
| 44 | 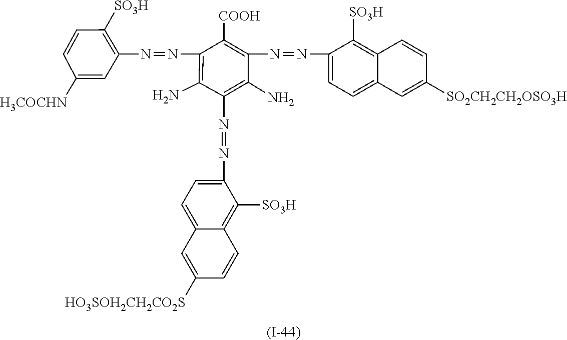 | 440 |
| 45 | 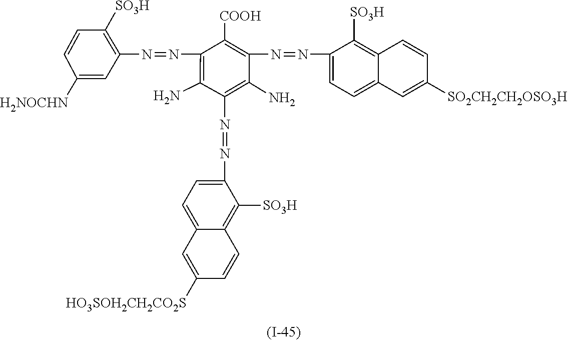 | 440 |
| 46 | 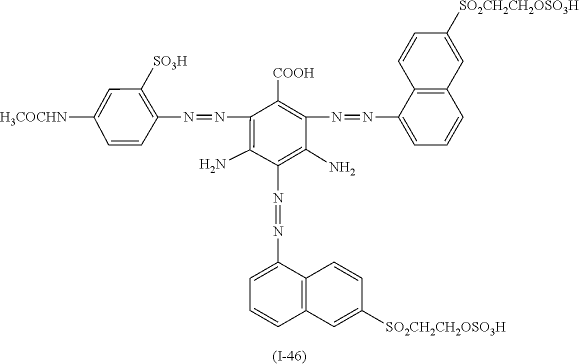 | 435 |
| 47 | 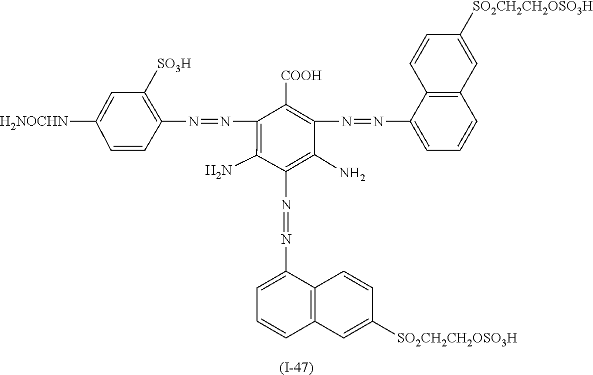 | 435 |
| 48 | 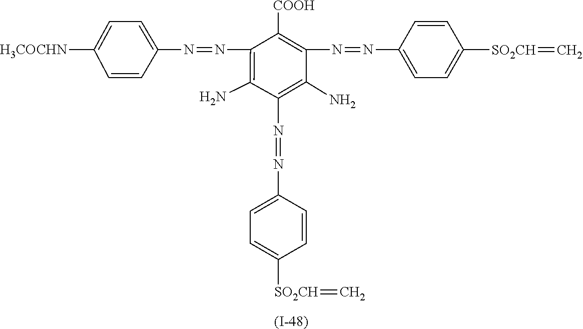 | 415 |
| 49 | 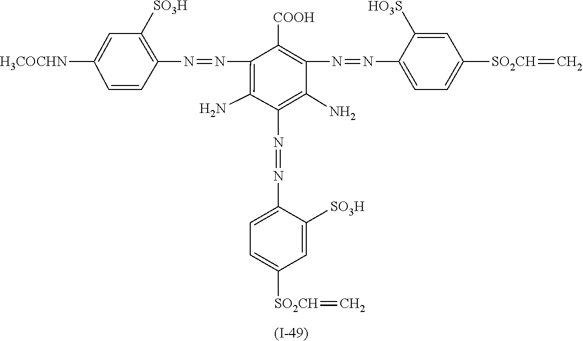 | 425 |
| 50 | 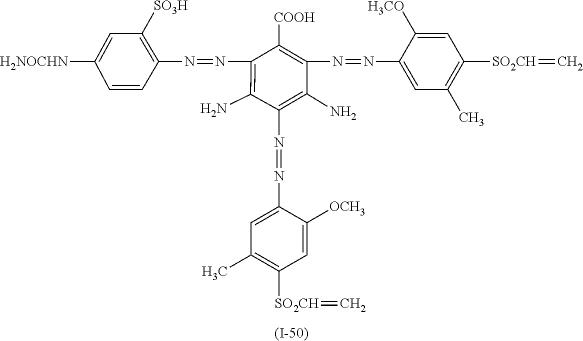 | 418 |
| 51 | 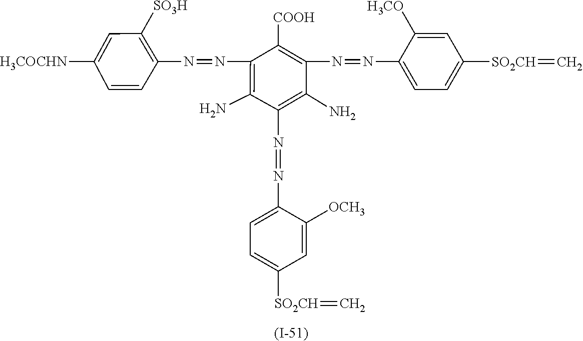 | 418 |
| 52 | 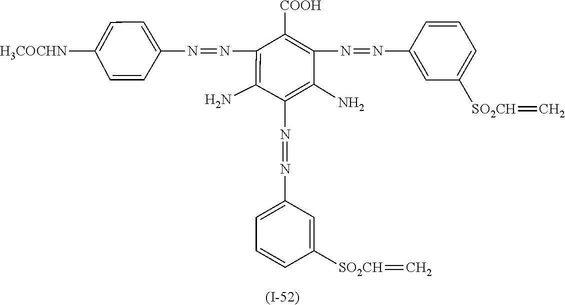 | 415 |
| 53 | 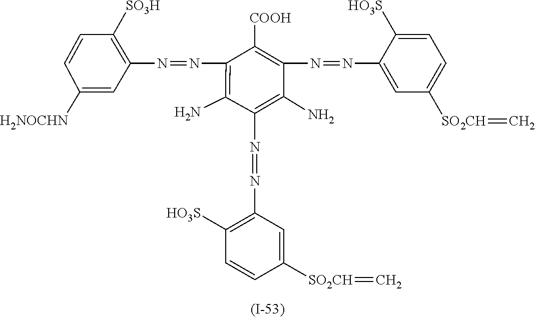 | 425 |
| 54 | 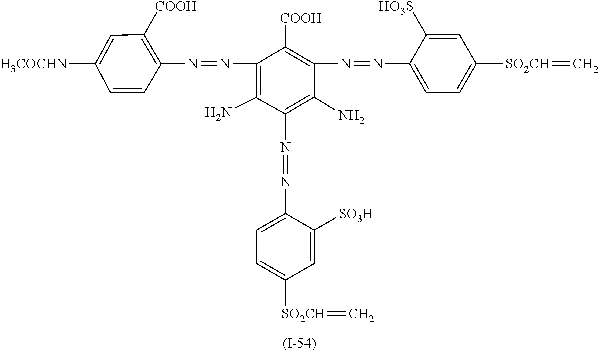 | 422 |
| 55 | 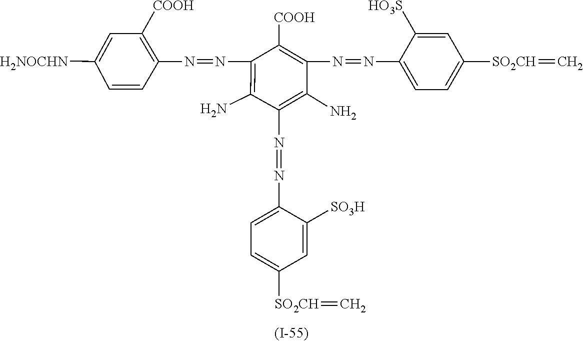 | 422 |
| 56 | 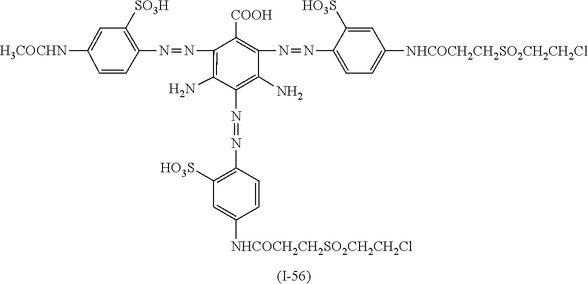 | 428 |
| 57 | 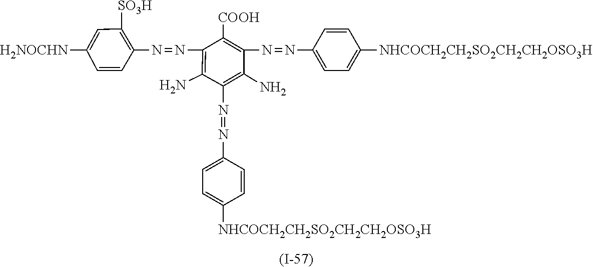 | 425 |
| 58 | 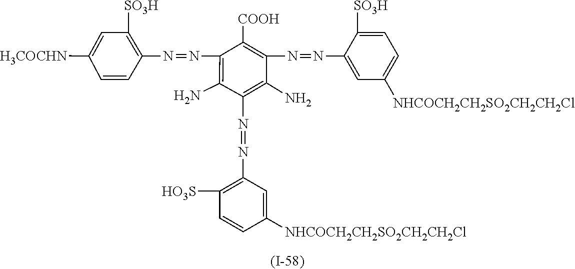 | 430 |
| 59 | 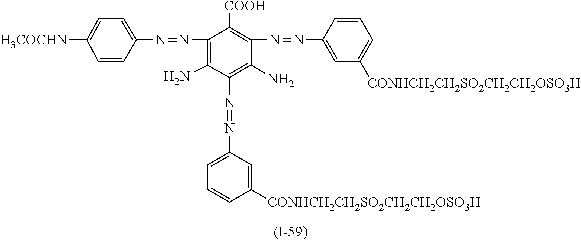 | 420 |
| 60 | 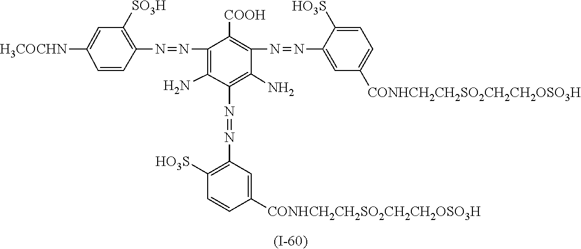 | 430 |
| 61 | 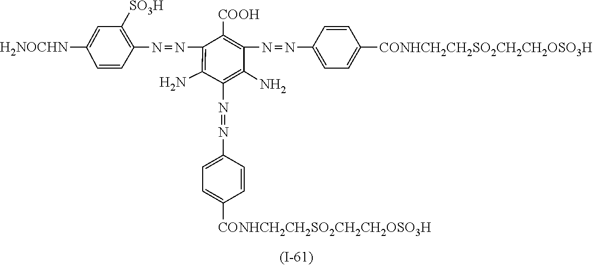 | 425 |
| 62 | 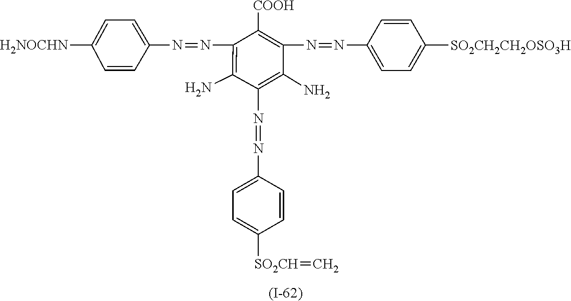 | 415 |
| 63 | 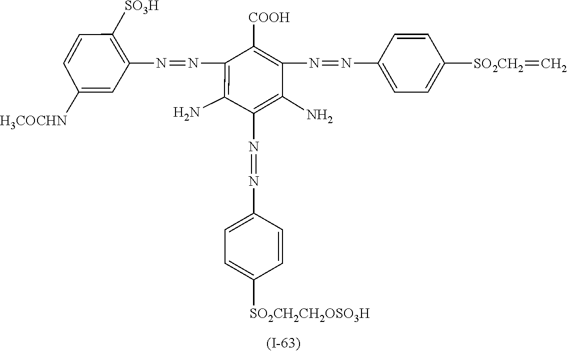 | 420 |
| 64 | 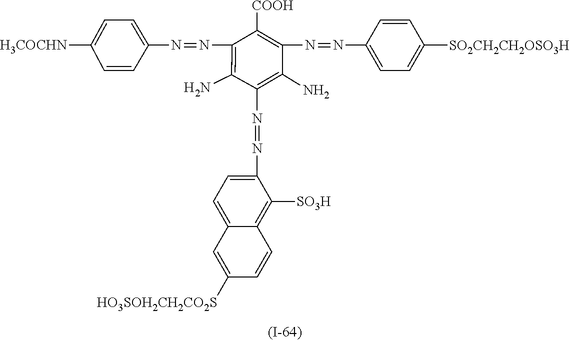 | 430 |
| 65 | 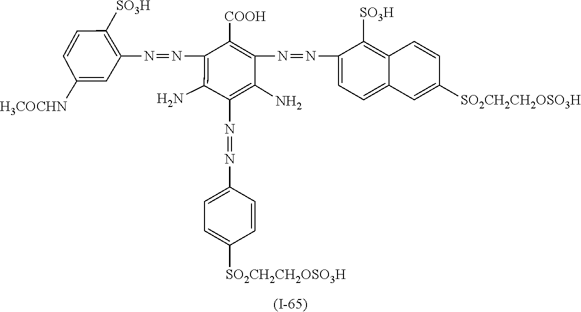 | 430 |
| 66 | 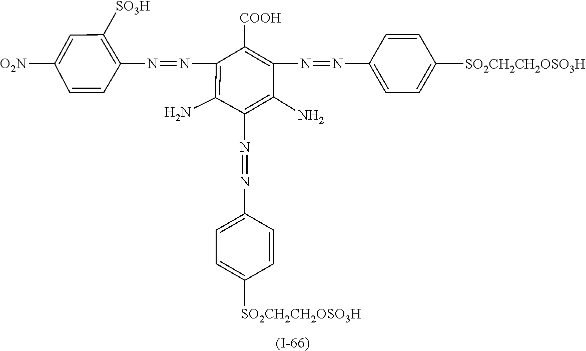 | 420 |

### Comparative Example 1

According to example 38 in patent CN1266869A, the reactive dye compound of the formula (1) was prepared:

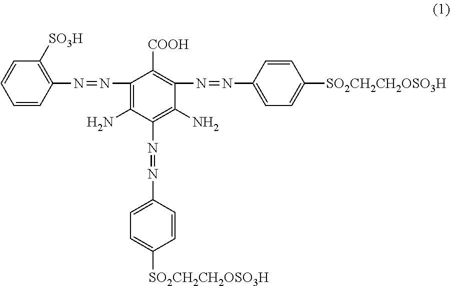

### Comparative Example 2

According to example 1 in patent CN105694530A, the reactive dye compound of the formula (2) was prepared:

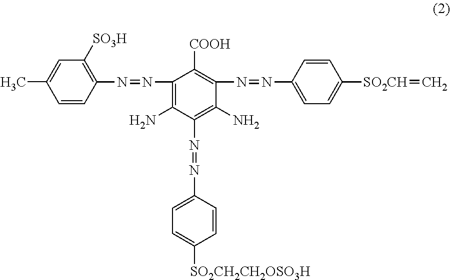

### Comparative Example 3

According to example 1 in patent CN101319096A, the reactive dye compound of the formula (3) was prepared:

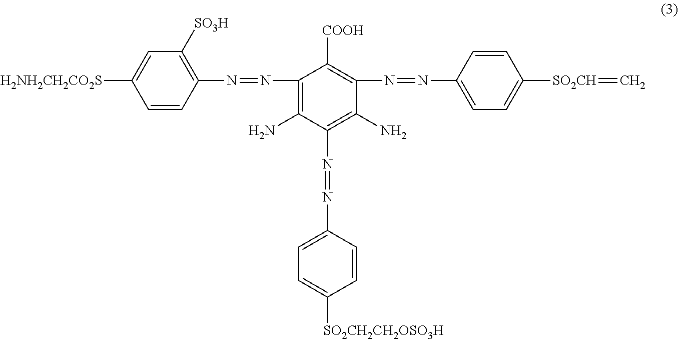

### Application Example 1

The dried reactive dyes obtained in examples 1-66 and comparative examples 1-3 were respectively dissolved in water and added with sodium sulfate powder with a final concentration of 50 g/L to prepare a dyeing solution. The dyeing concentration (dye to cloth weight) was set at 4%, the bath ratio (gram weight of cloth to milliliter volume of dyeing solution) was set at 1:20, cotton was placed in the bath for adsorption at 60° C. for 30 minutes, alkali (sodium carbonate 20 g/L) was added for dye fixation for 45 minutes, the dyed fabric was washed with water, soaped, and dried to obtain a yellow to orange dyed fabric. Tests of fastnesses to washing and rubbing were carried out according to methods in ISO 105 C10-2006 and ISO 105 X12. The results are shown in table 2:

TABLE 2

| | Fastness to washing (ISO 105 C10-2006), grade | | | | | | Fastness to | |
|---|---|---|---|---|---|---|---|---|
| | 95° C. × 30 min | | | | | | rubbing, grade | |
| Examples | Acetate | Cotton | Nylon | Polyester | Acrylic | Wool | Dry | Wet |
| 1 | 4-5 | 4 | 4 | 5 | 4-5 | 4 | 4-5 | 3-4 |
| 2 | 4-5 | 4 | 4 | 5 | 4-5 | 4 | 4-5 | 3-4 |
| 3 | 4-5 | 4 | 4 | 5 | 4-5 | 4 | 4-5 | 3-4 |
| 4 | 4-5 | 4 | 4 | 5 | 4-5 | 4 | 4-5 | 3-4 |
| 5 | 4-5 | 4 | 4 | 5 | 4-5 | 4 | 4-5 | 3-4 |
| 6 | 4-5 | 4-5 | 4 | 5 | 4-5 | 4 | 4-5 | 3-4 |
| 7 | 4-5 | 4-5 | 4 | 5 | 4-5 | 4 | 4-5 | 3-4 |
| 8 | 4-5 | 4-5 | 4 | 5 | 4-5 | 4 | 4-5 | 3-4 |
| 9 | 4-5 | 4 | 4 | 5 | 4-5 | 4 | 4-5 | 3-4 |
| 10 | 4-5 | 4 | 4 | 5 | 4-5 | 4 | 4-5 | 3-4 |
| 11 | 4-5 | 4 | 4 | 5 | 4-5 | 4 | 4-5 | 3-4 |
| 12 | 4-5 | 4 | 4 | 5 | 4-5 | 4 | 4-5 | 3-4 |
| 13 | 4-5 | 4 | 4 | 5 | 4-5 | 4 | 4-5 | 3-4 |
| 14 | 4-5 | 4 | 4 | 5 | 4-5 | 4 | 4-5 | 3-4 |
| 15 | 4-5 | 4 | 4 | 5 | 4-5 | 4 | 4-5 | 3-4 |
| 16 | 4-5 | 4 | 4 | 5 | 4-5 | 4 | 4-5 | 3-4 |
| 17 | 4-5 | 4 | 4 | 5 | 4-5 | 4 | 4-5 | 3-4 |
| 18 | 4-5 | 4-5 | 4 | 5 | 4-5 | 4 | 4-5 | 3-4 |
| 19 | 4-5 | 4-5 | 4 | 5 | 4-5 | 4 | 4-5 | 3-4 |
| 20 | 4-5 | 4 | 4 | 5 | 4-5 | 4 | 4-5 | 3-4 |
| 21 | 4-5 | 4 | 4 | 5 | 4-5 | 4 | 4-5 | 3-4 |
| 22 | 4-5 | 4 | 4 | 5 | 4-5 | 4 | 4-5 | 3-4 |
| 23 | 4-5 | 4 | 4 | 5 | 4-5 | 4 | 4-5 | 3-4 |
| 24 | 4-5 | 4 | 4 | 5 | 4-5 | 4 | 4-5 | 3-4 |
| 25 | 4-5 | 4-5 | 4 | 5 | 4-5 | 4 | 4-5 | 3-4 |
| 26 | 4-5 | 4-5 | 4 | 5 | 4-5 | 4 | 4-5 | 3-4 |
| 27 | 4-5 | 4-5 | 4 | 5 | 4-5 | 4 | 4-5 | 3-4 |
| 28 | 4-5 | 4-5 | 4 | 5 | 4-5 | 4 | 4-5 | 3-4 |
| 29 | 4 | 4 | 4 | 4-5 | 4-5 | 4 | 4-5 | 3-4 |
| 30 | 4 | 4 | 4 | 4-5 | 4-5 | 4 | 4-5 | 3-4 |
| 31 | 4 | 4 | 4 | 4-5 | 4-5 | 4 | 4-5 | 3-4 |
| 32 | 4 | 4 | 4 | 4-5 | 4-5 | 4 | 4-5 | 3-4 |
| 33 | 4 | 4 | 4 | 4-5 | 4-5 | 4 | 4-5 | 3-4 |
| 34 | 4 | 4 | 4 | 4-5 | 4-5 | 4 | 4-5 | 3-4 |
| 35 | 4 | 4 | 4 | 4-5 | 4-5 | 4 | 4-5 | 3-4 |
| 36 | 4 | 4 | 4 | 4-5 | 4-5 | 4 | 4-5 | 3-4 |
| 37 | 4 | 4 | 4 | 4-5 | 4-5 | 4 | 4-5 | 3-4 |
| 38 | 4 | 4 | 4 | 4-5 | 4-5 | 4 | 4-5 | 3-4 |
| 39 | 4 | 4 | 4 | 4-5 | 4-5 | 4 | 4-5 | 3-4 |
| 40 | 4 | 4 | 4 | 4-5 | 4-5 | 4 | 4-5 | 3-4 |
| 41 | 4 | 4 | 4 | 4-5 | 4-5 | 4 | 4-5 | 3-4 |
| 42 | 4 | 4 | 4 | 4-5 | 4-5 | 4 | 4-5 | 3-4 |
| 43 | 4 | 4 | 4 | 4-5 | 4-5 | 4 | 4-5 | 3-4 |
| 44 | 4 | 4 | 4 | 4-5 | 4-5 | 4 | 4-5 | 3-4 |
| 45 | 4 | 4 | 4 | 4-5 | 4-5 | 4 | 4-5 | 3-4 |
| 46 | 4 | 4 | 4 | 4-5 | 4-5 | 4 | 4-5 | 3-4 |
| 47 | 4 | 4 | 4 | 4-5 | 4-5 | 4 | 4-5 | 3-4 |
| 48 | 4-5 | 4-5 | 4 | 5 | 4-5 | 4 | 4-5 | 3-4 |
| 49 | 4-5 | 4-5 | 4 | 5 | 4-5 | 4 | 4-5 | 3-4 |
| 50 | 4-5 | 4-5 | 4 | 5 | 4-5 | 4 | 4-5 | 3-4 |
| 51 | 4-5 | 4-5 | 4 | 5 | 4-5 | 4 | 4-5 | 3-4 |
| 52 | 4-5 | 4-5 | 4 | 5 | 4-5 | 4 | 4-5 | 3-4 |
| 53 | 4-5 | 4-5 | 4 | 5 | 4-5 | 4 | 4-5 | 3-4 |
| 54 | 4-5 | 4-5 | 4 | 5 | 4-5 | 4 | 4-5 | 3-4 |
| 55 | 4-5 | 4-5 | 4 | 5 | 4-5 | 4 | 4-5 | 3-4 |
| 56 | 4 | 4 | 4 | 4-5 | 4-5 | 4 | 4-5 | 3-4 |
| 57 | 4 | 4 | 4 | 4-5 | 4-5 | 4 | 4-5 | 3-4 |
| 58 | 4 | 4 | 4 | 4-5 | 4-5 | 4 | 4-5 | 3-4 |
| 59 | 4 | 4 | 4 | 4-5 | 4-5 | 4 | 4-5 | 3-4 |
| 60 | 4 | 4 | 4 | 4-5 | 4-5 | 4 | 4-5 | 3-4 |
| 61 | 4 | 4 | 4 | 4-5 | 4-5 | 4 | 4-5 | 3-4 |
| 62 | 4 | 4 | 4 | 4-5 | 4-5 | 4 | 4-5 | 3-4 |
| 63 | 4 | 4 | 4 | 4-5 | 4-5 | 4 | 4-5 | 3-4 |
| 64 | 4 | 4 | 4 | 4-5 | 4-5 | 4 | 4-5 | 3-4 |
| 65 | 4 | 4 | 4 | 4-5 | 4-5 | 4 | 4-5 | 3-4 |
| 66 | 4 | 4 | 4 | 4-5 | 4-5 | 4 | 4-5 | 3-4 |
| Comparative | 4 | 3-4 | 3-4 | 4 | 4 | 3 | 4-5 | 3 |
| example 1 | | | | | | | | |
| Comparative | 4 | 3-4 | 3-4 | 4 | 4 | 3 | 4-5 | 3-4 |
| example 2 | | | | | | | | |
| Comparative | 4 | 4 | 3-4 | 4 | 4 | 3-4 | 4 | 3 |
| example 3 | | | | | | | | |

From table 2, we can see that the reactive dyes of the present invention are significantly superior to those of the prior art in fastness to washing and rubbing.

1. A reactive dye compound, which is a compound of the following formula (I) or an alkali metal salt thereof: 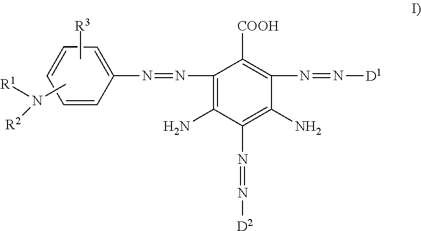
in formula (I):
D¹ and D² are each independently the group of the following formula (a) or (b): 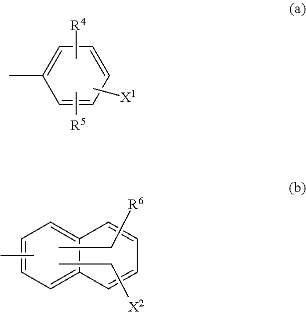
in the above formulae (I), (a) and (b):
R¹ and R² are each independently hydrogen, —COR⁷, C₁˜C₄ alkyl or C₁˜C₄ alkyl substituted by hydroxyl, sulfo or carboxyl, in which R⁷ is C₁˜C₄ alkyl, C₂˜C₄ alkenyl or —NH₂;
R³ is hydrogen, C₁˜C₄ alkyl, C₁˜C₄ alkoxy, carboxyl or sulfo;
R⁴˜R⁶ are each independently hydrogen, C₁˜C₄ alkyl, C₁˜C₄ alkoxy or sulfo;
X¹ and X² are each independently —SO₂Y¹, —NHCO(CH₂)ₚSO₂Y² or —CONH(CH₂)_{q}SO₂Y³, in which Y¹˜Y³ are each independently —CH═CH₂, —CH₂CH₂OSO₃H or —CH₂CH₂Cl, p=1-3 and q=1-3.

2. The reactive dye compound as claimed in claim 1, wherein both D¹ and D² are the group of formula (a) or (b).

3. The reactive dye compound as claimed in claim 1, wherein both D¹ and D² are the group of formula (a).

4. The reactive dye compound as claimed claim 1, wherein R¹ and R² are each independently hydrogen, —COR⁷, in which R⁷ is methyl or —NH₂; and R³ is hydrogen, methyl, methoxy, carboxyl or sulfo.

5. The reactive dye compound as claimed in claim 1, wherein R⁴˜R⁶ are each independently hydrogen, methyl, methoxy or sulfo; X¹ and X² are each independently —SO₂Y¹, —NHCOCH₂CH₂SO₂Y² or —CONHCH₂CH₂SO₂Y³, in which Y¹˜Y³ are each independently —CH═CH₂ or —CH₂CH₂OSO₃H.

6. The reactive dye compound as claimed in claim 1, wherein the group of formula (a) is selected from the group consisting of the following groups:

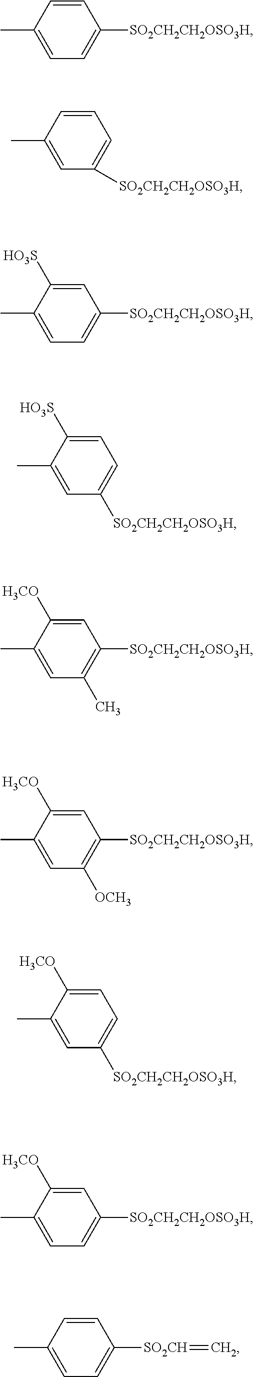

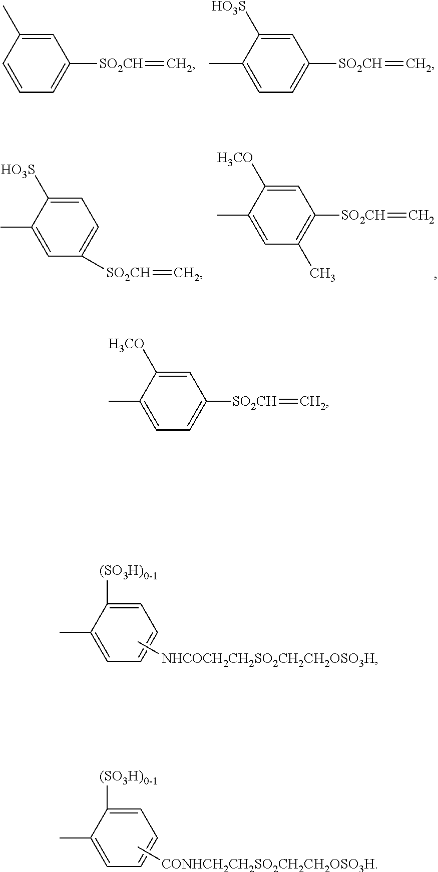

7. The reactive dye compound as claimed in claim 1, wherein the group of formula (b) is selected from the group consisting of the following groups:

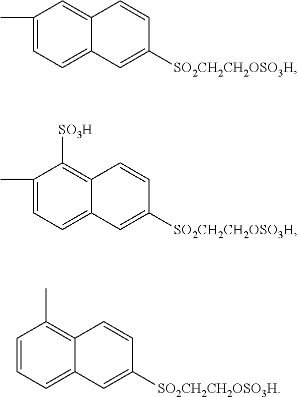

8. The reactive dye compound as claimed in claim 1, wherein the compound of formula (I) is selected from the group consisting of the following structures:

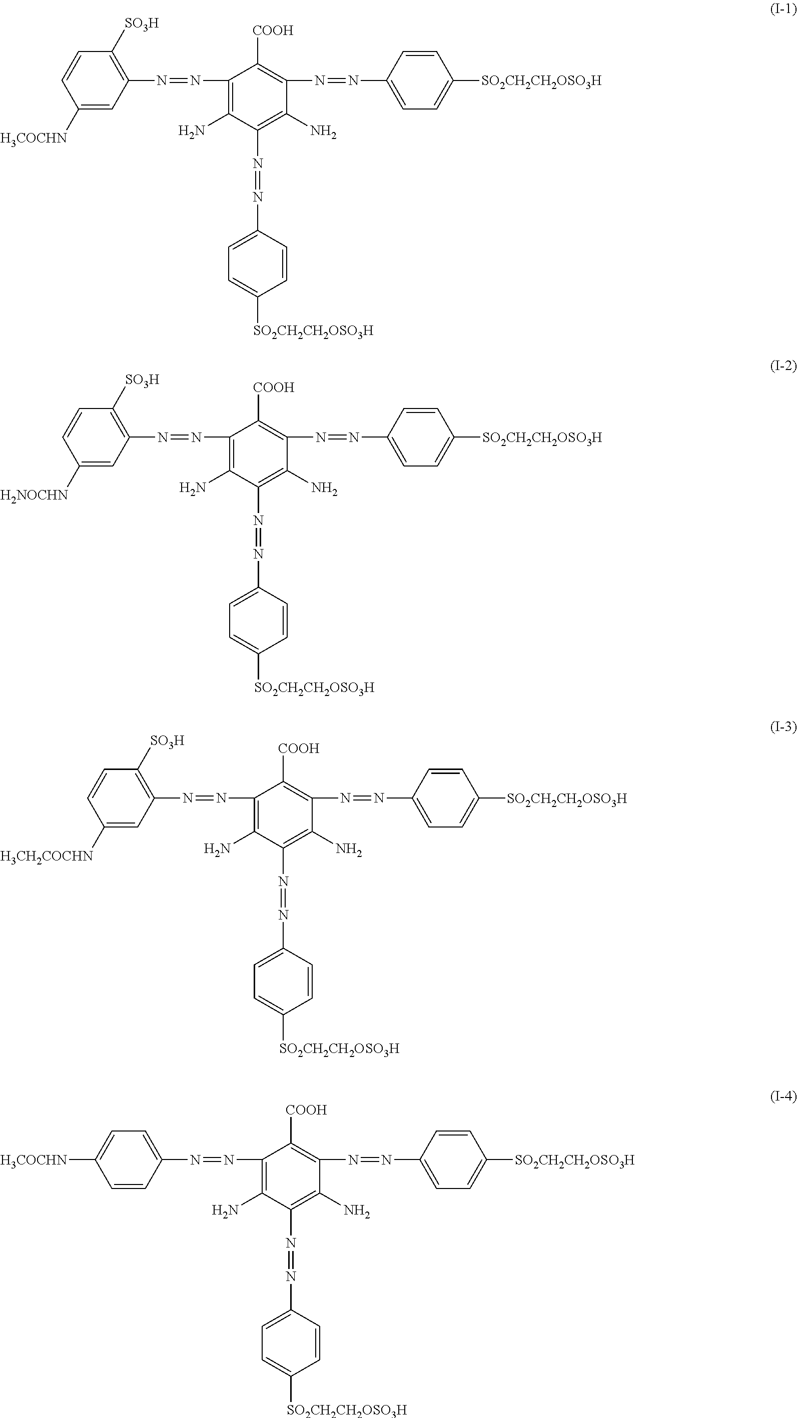

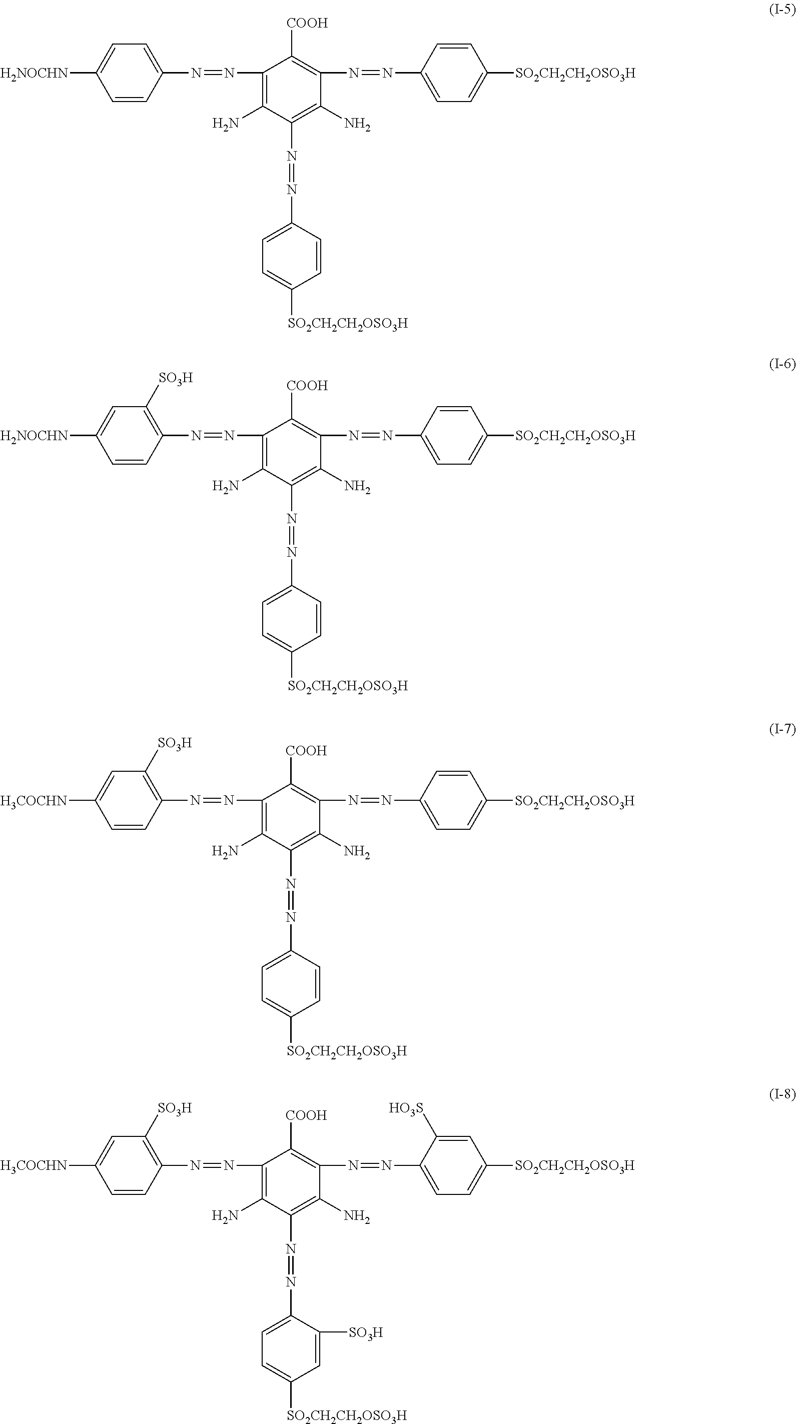

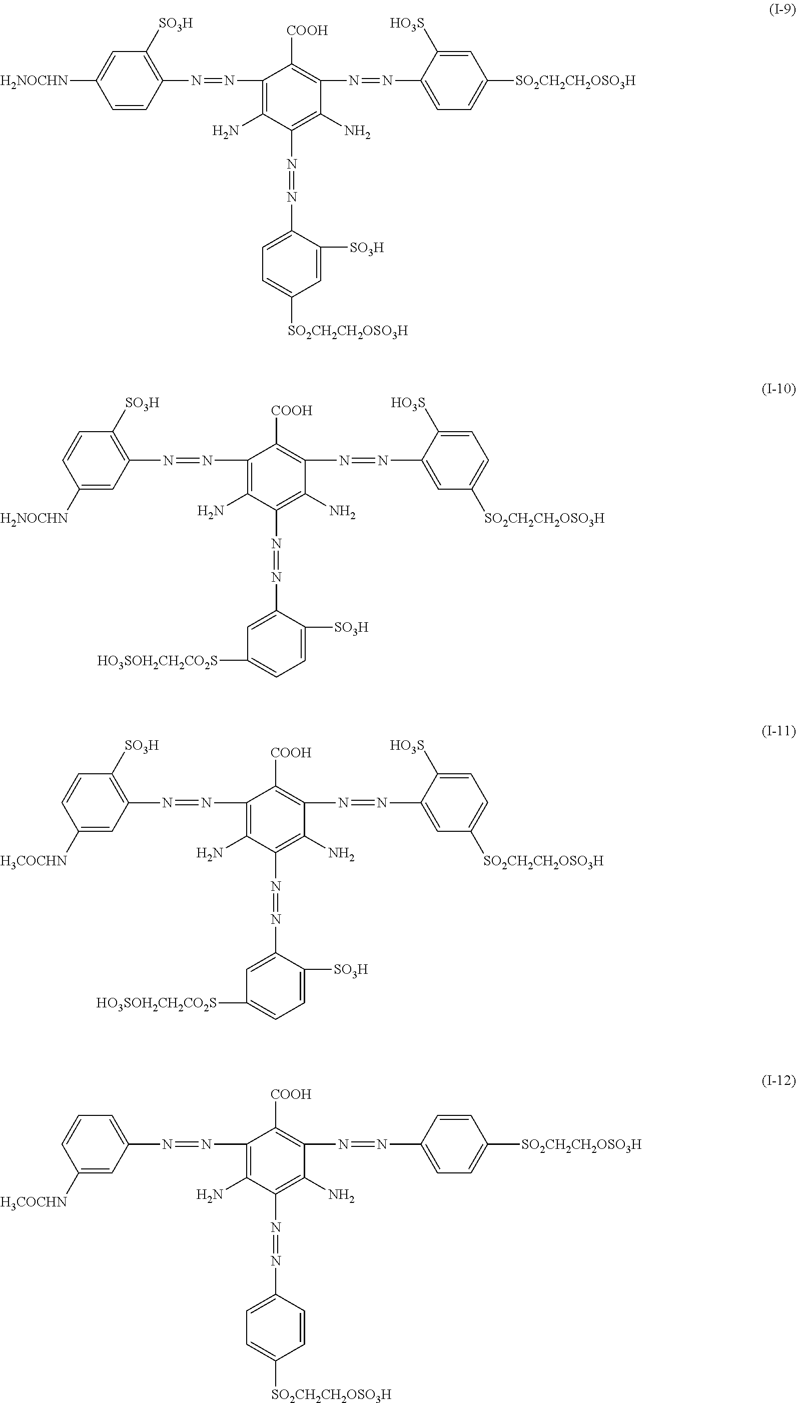

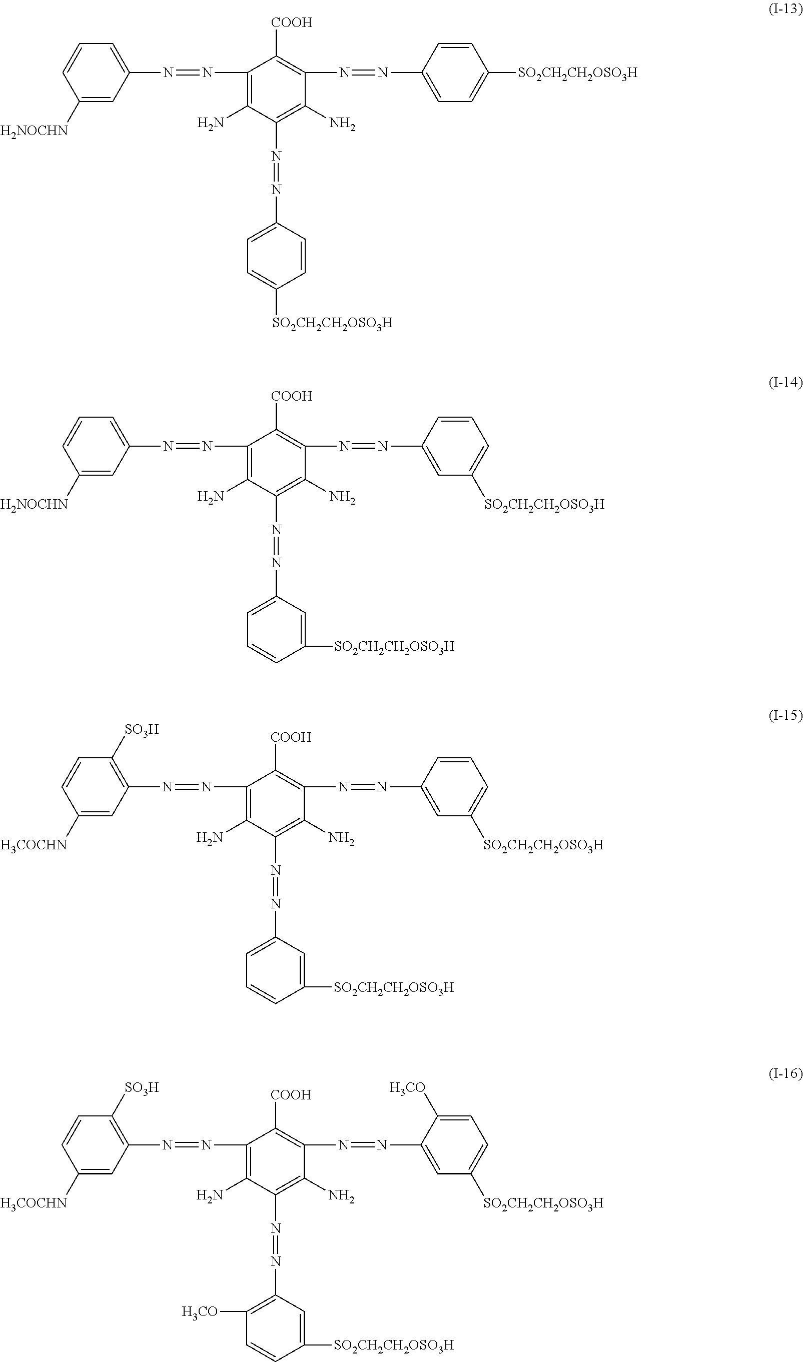

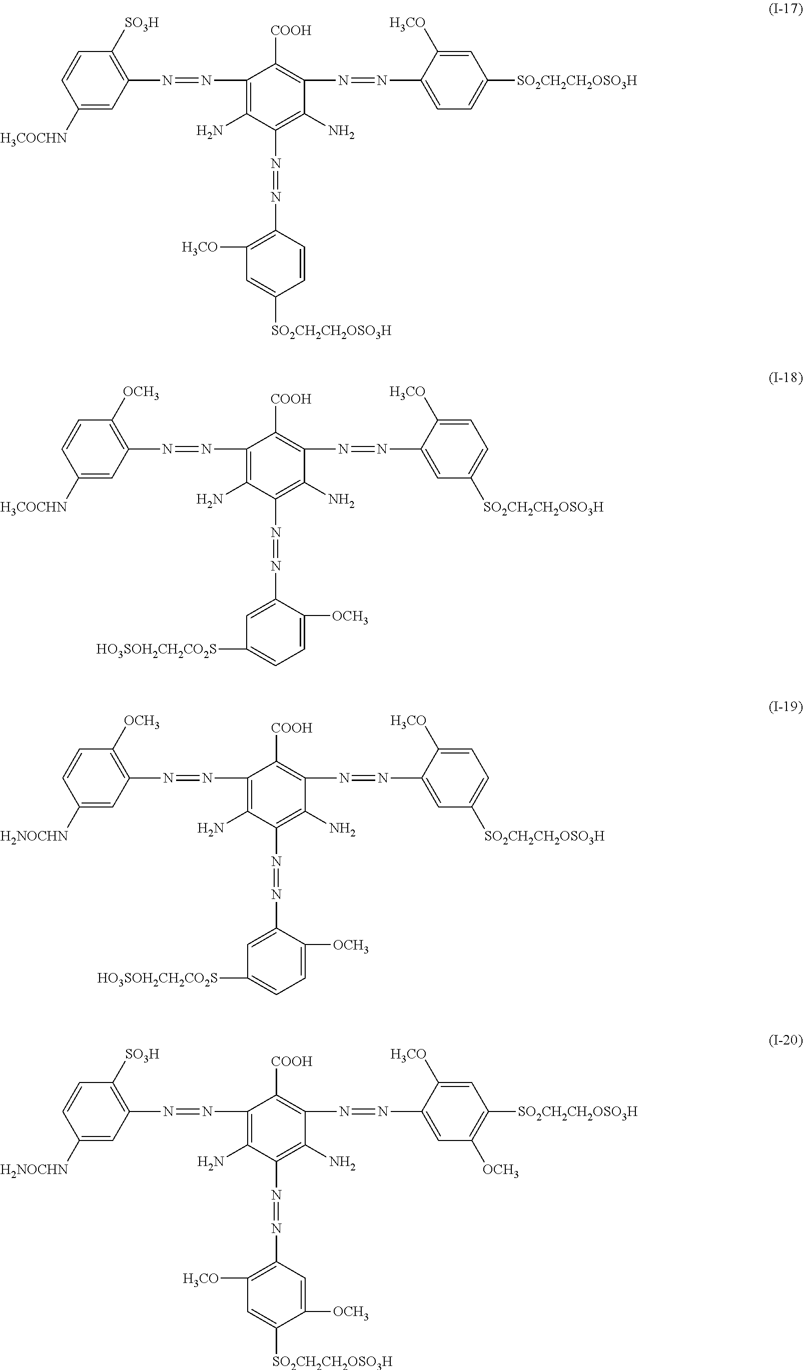

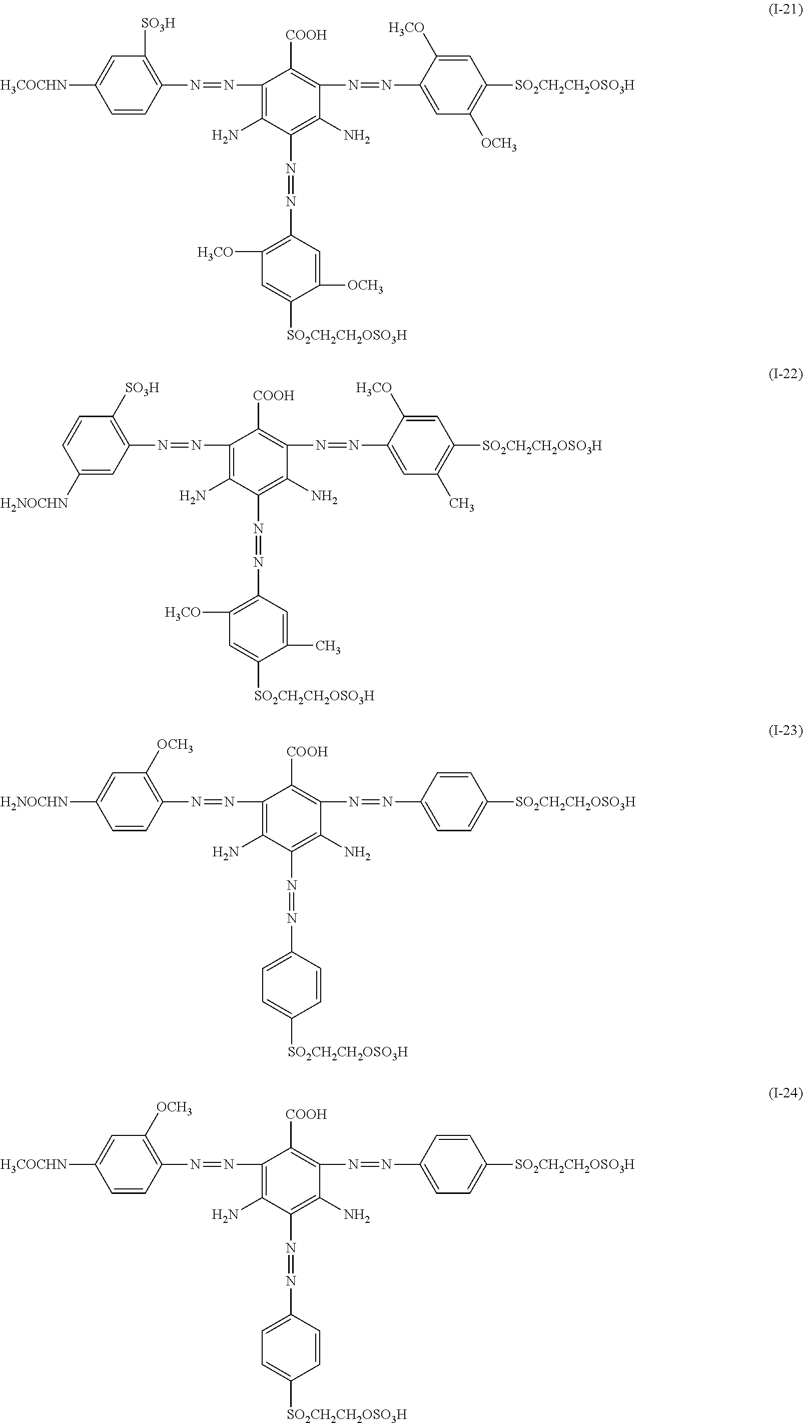

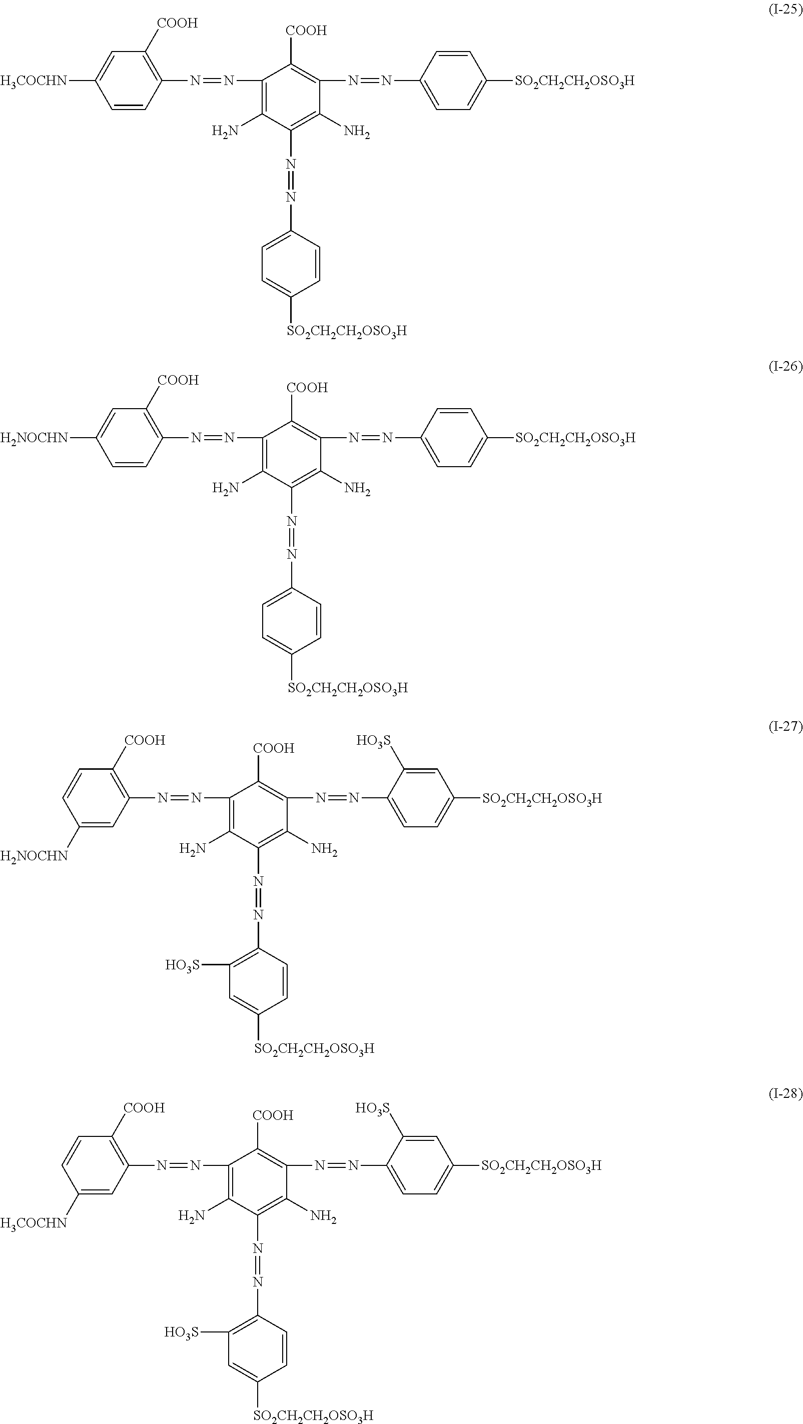

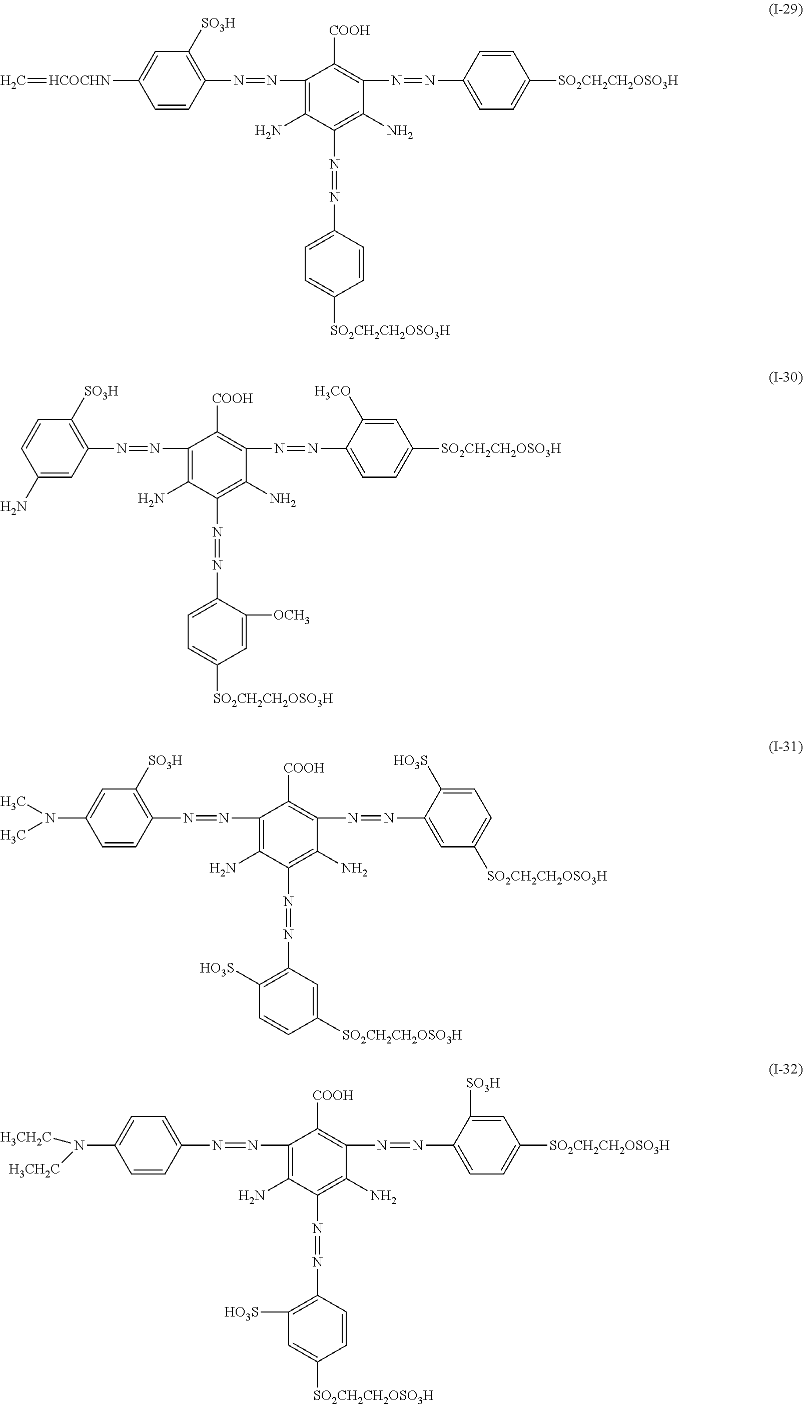

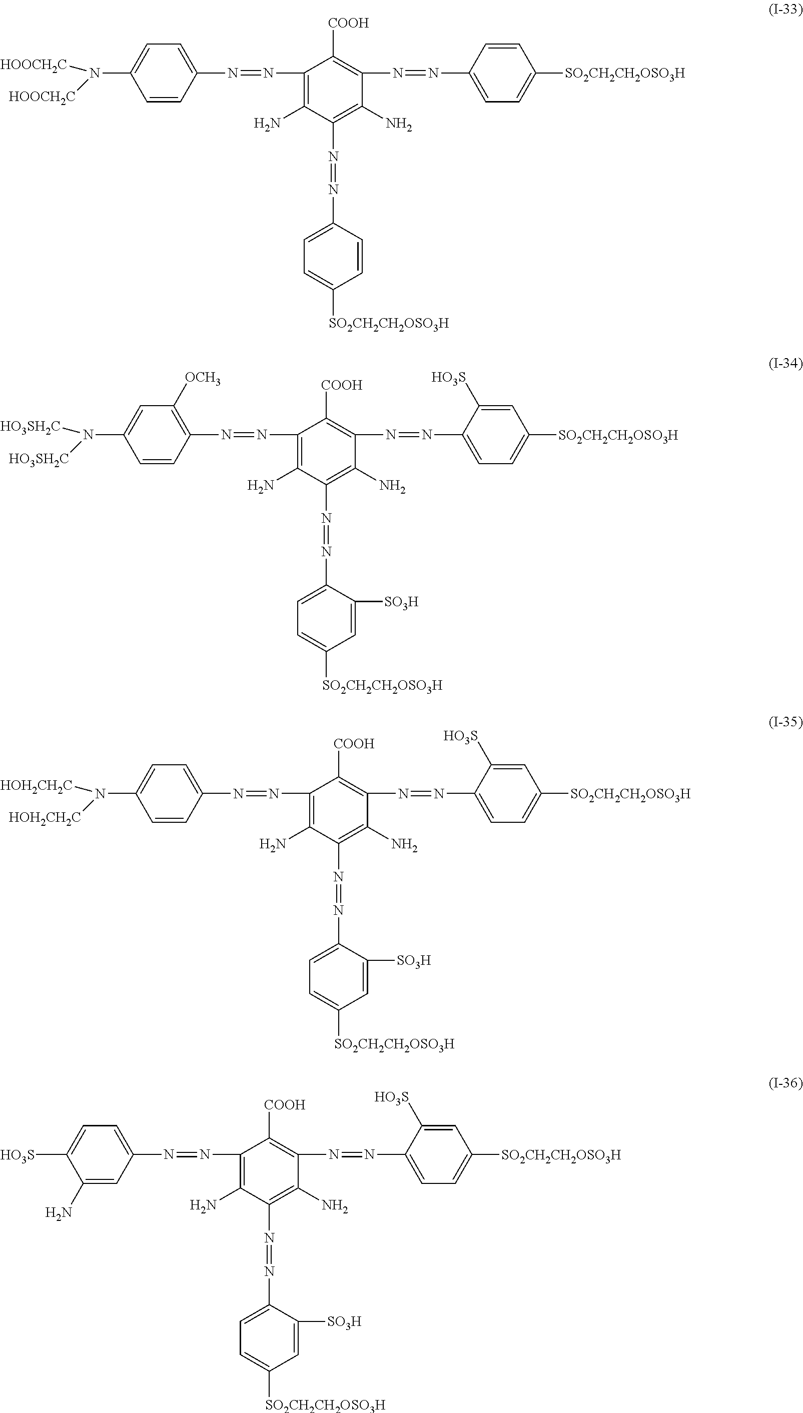

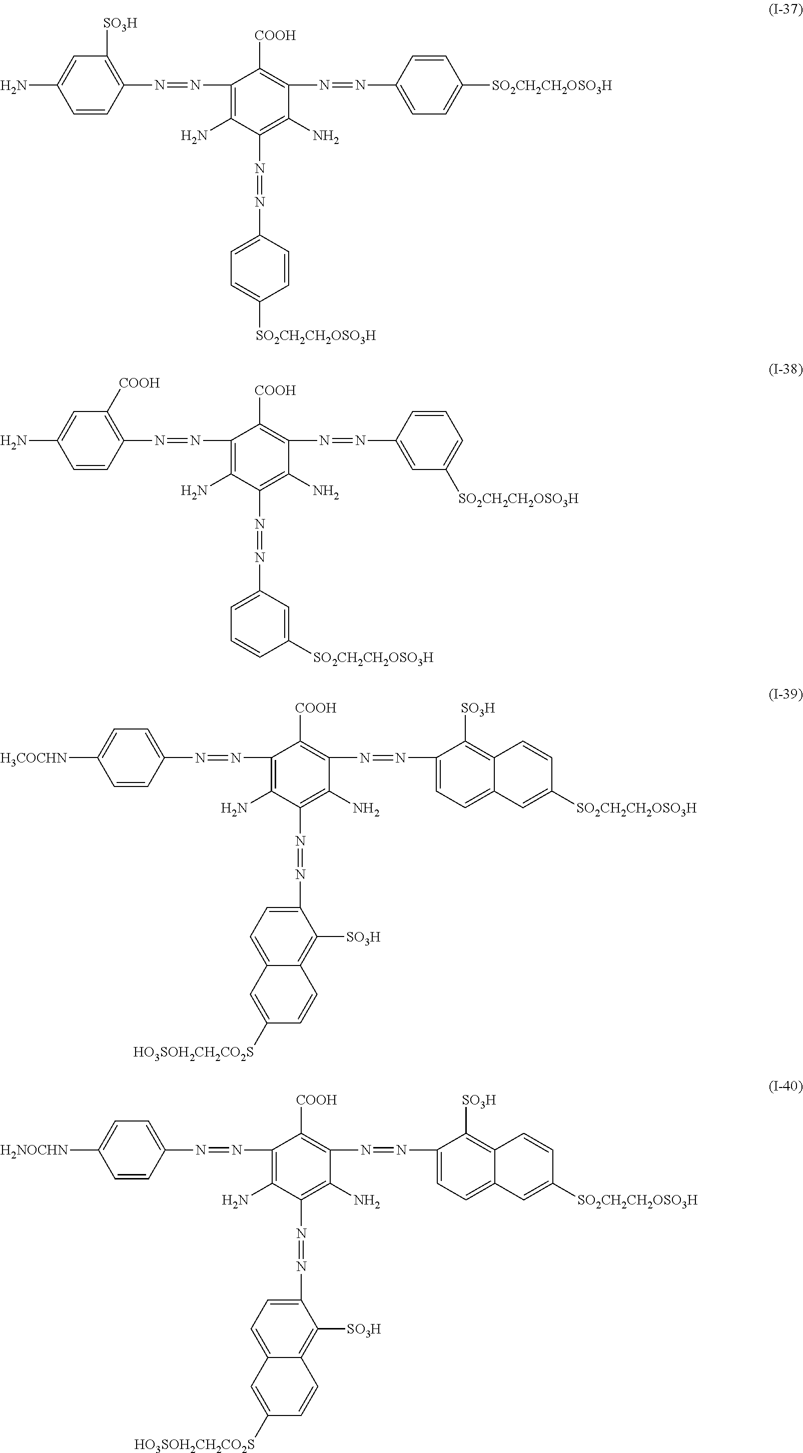

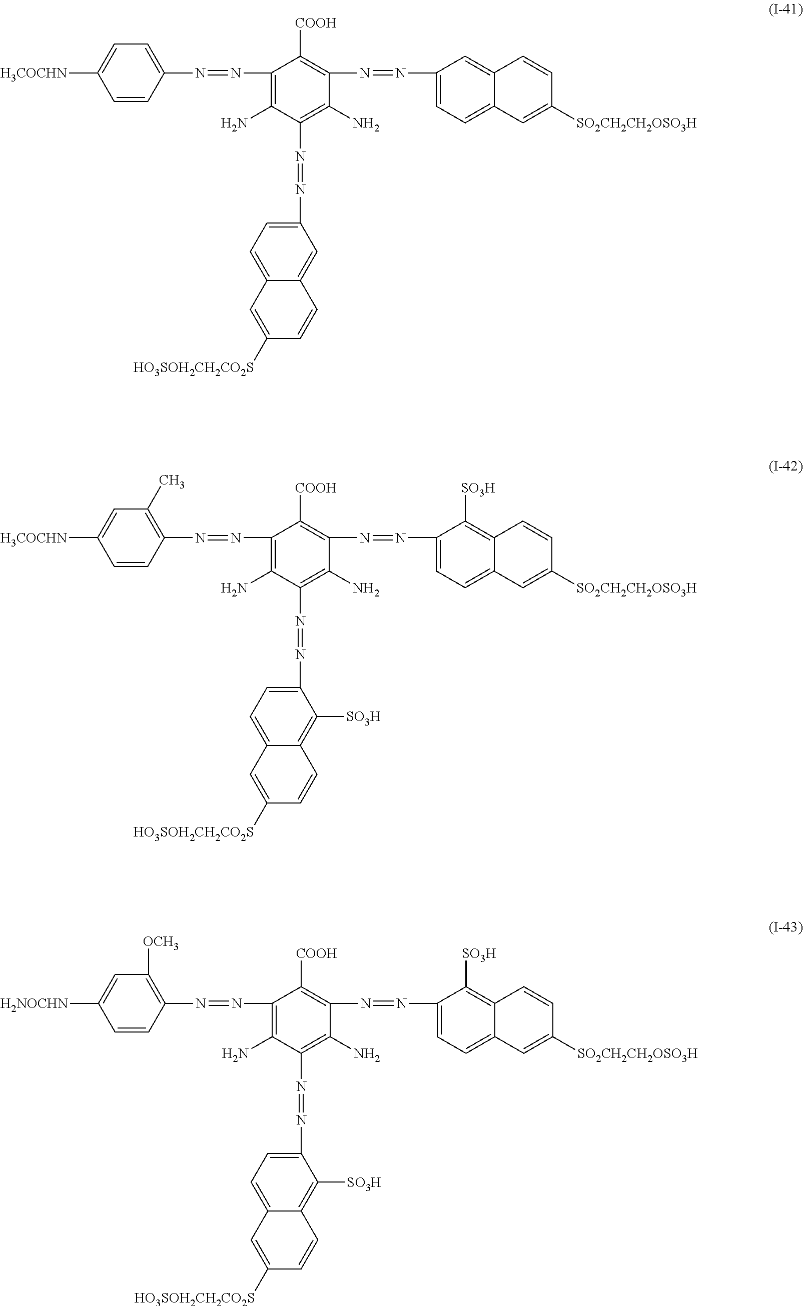

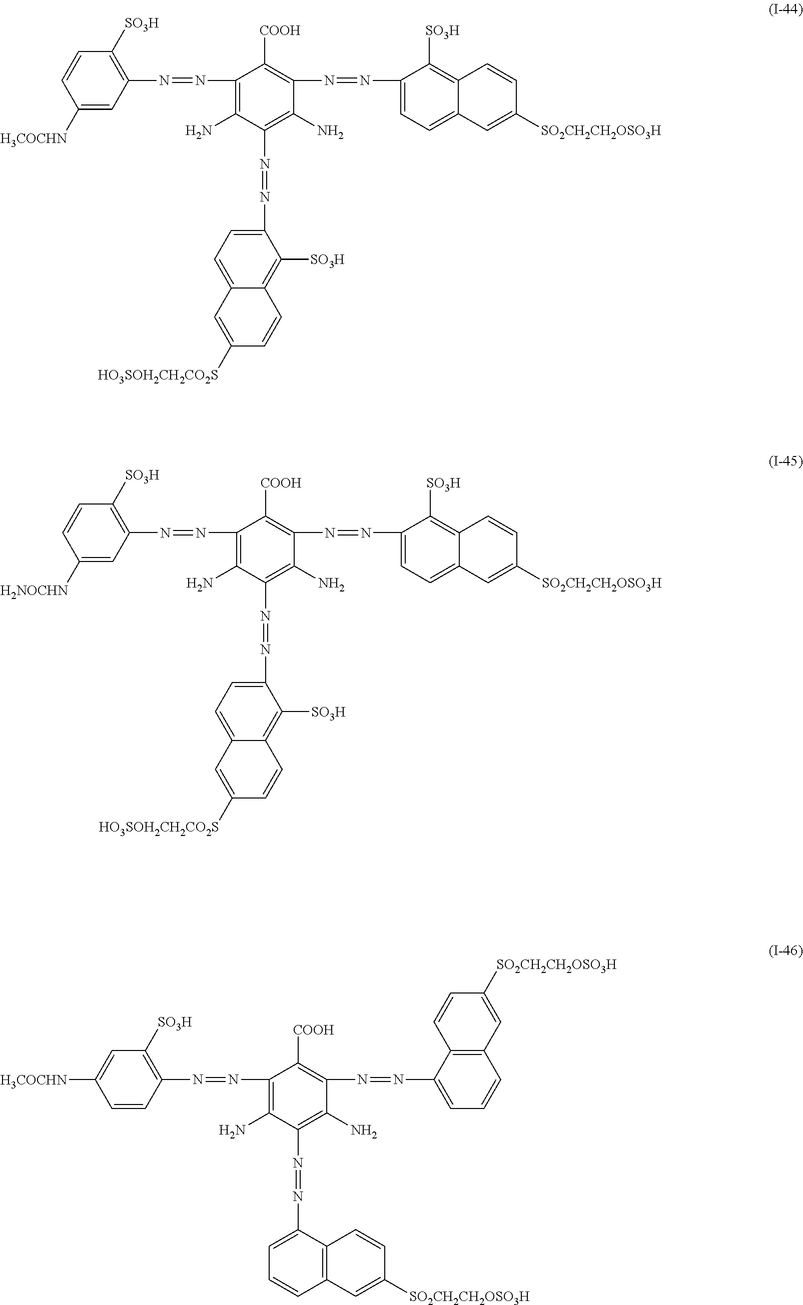

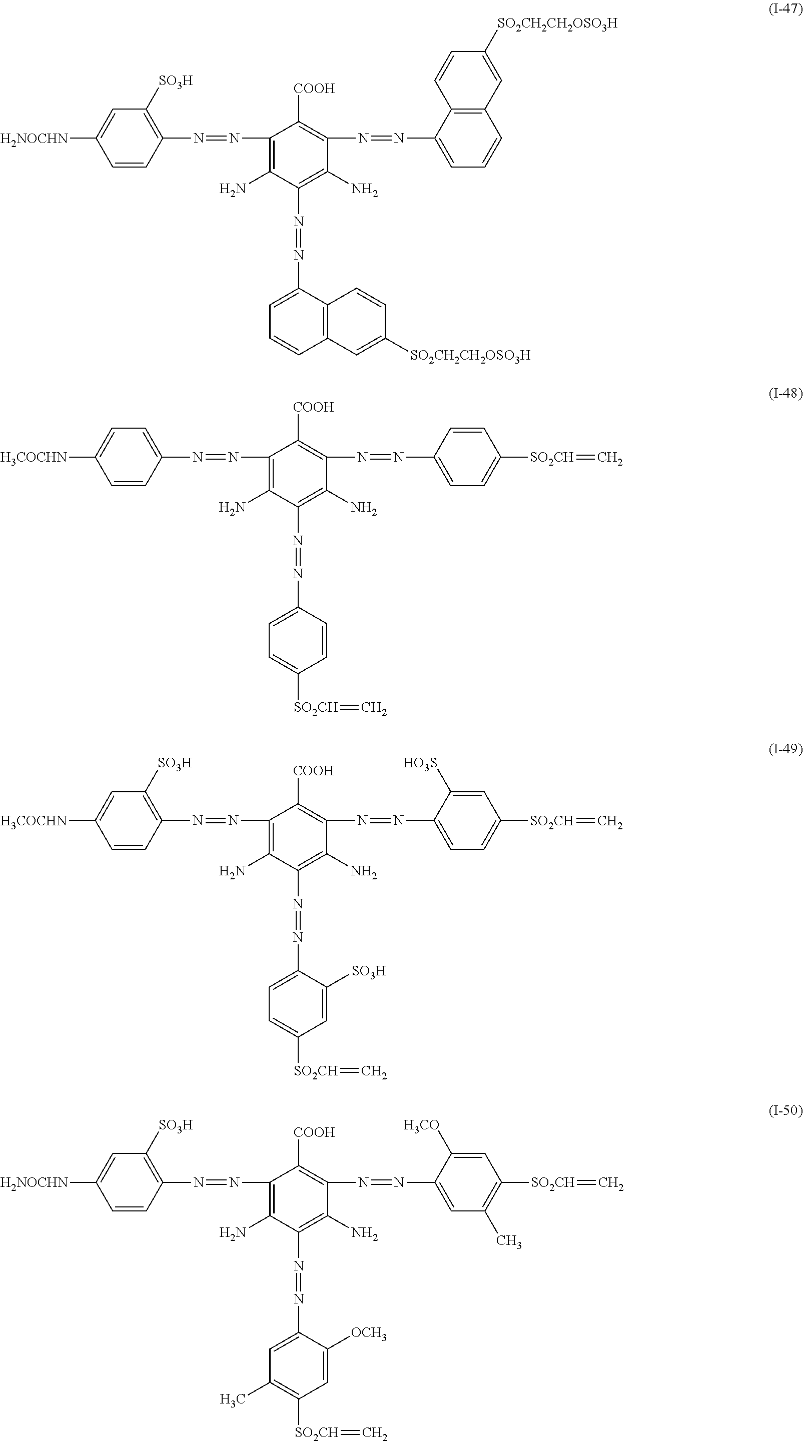

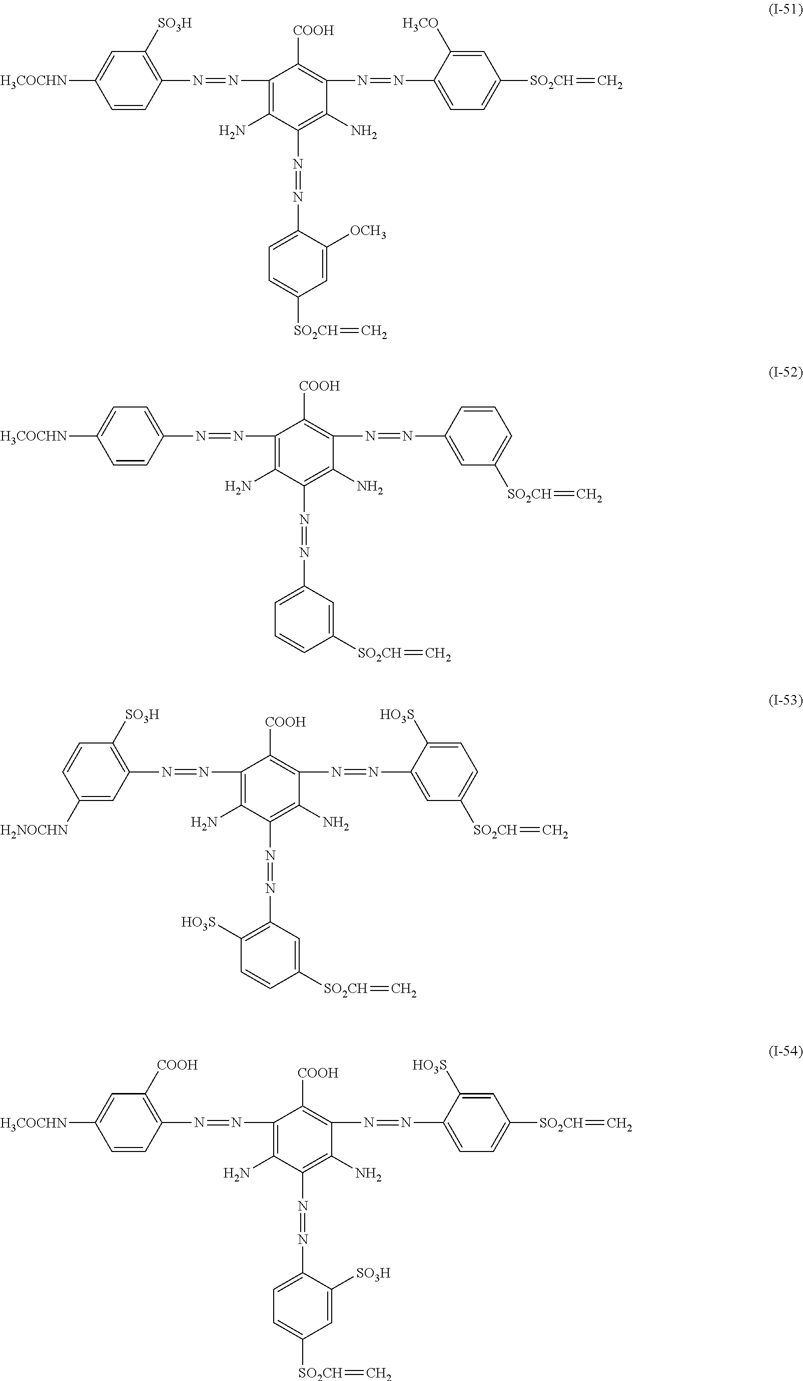

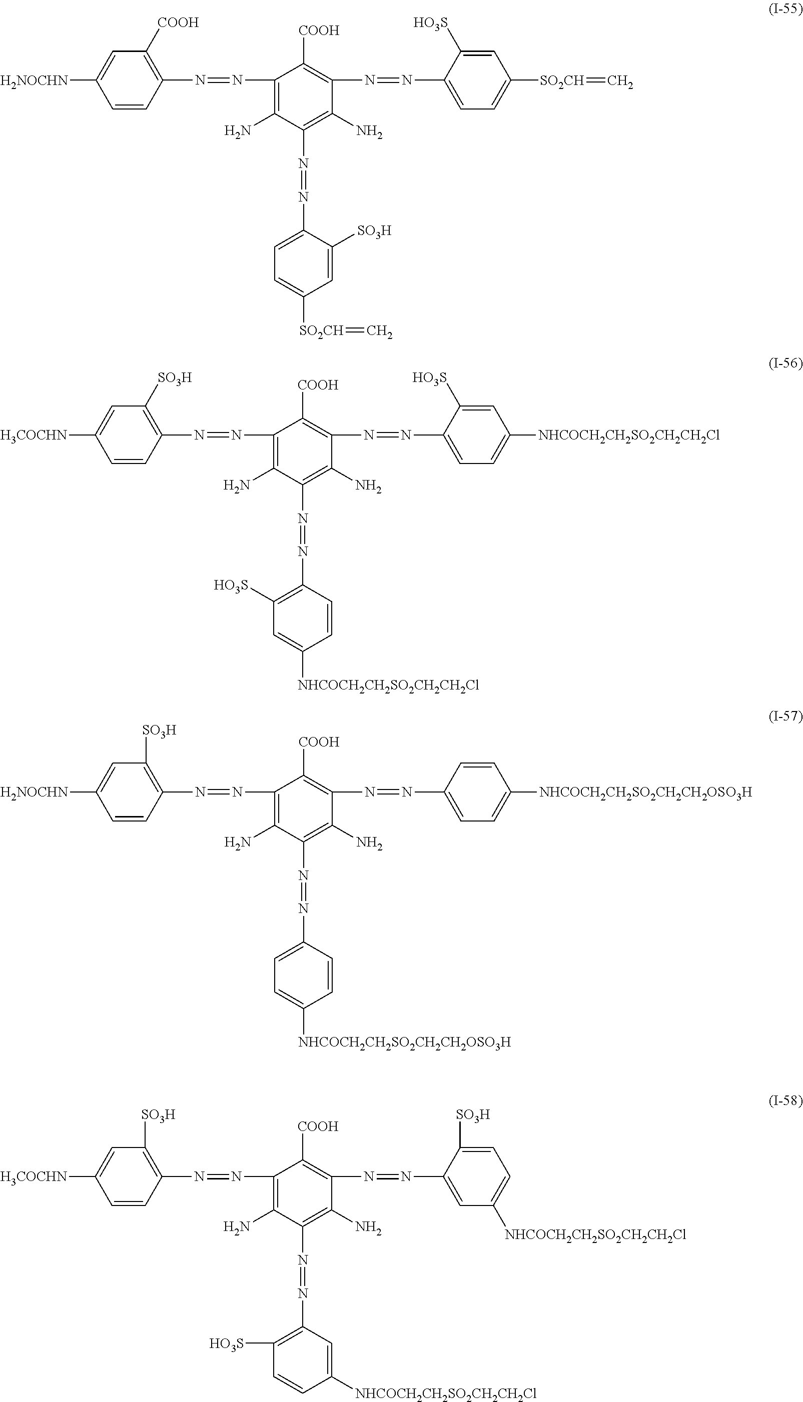

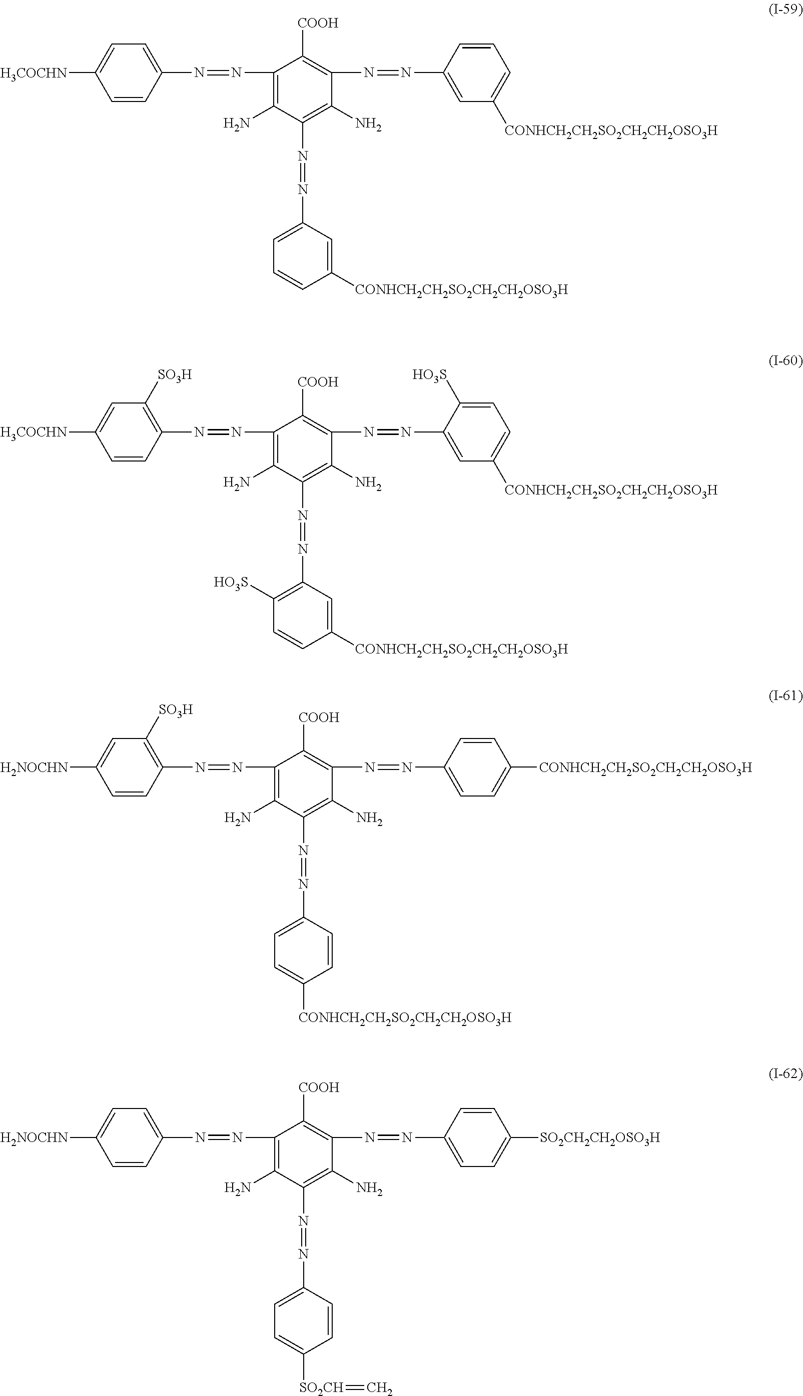

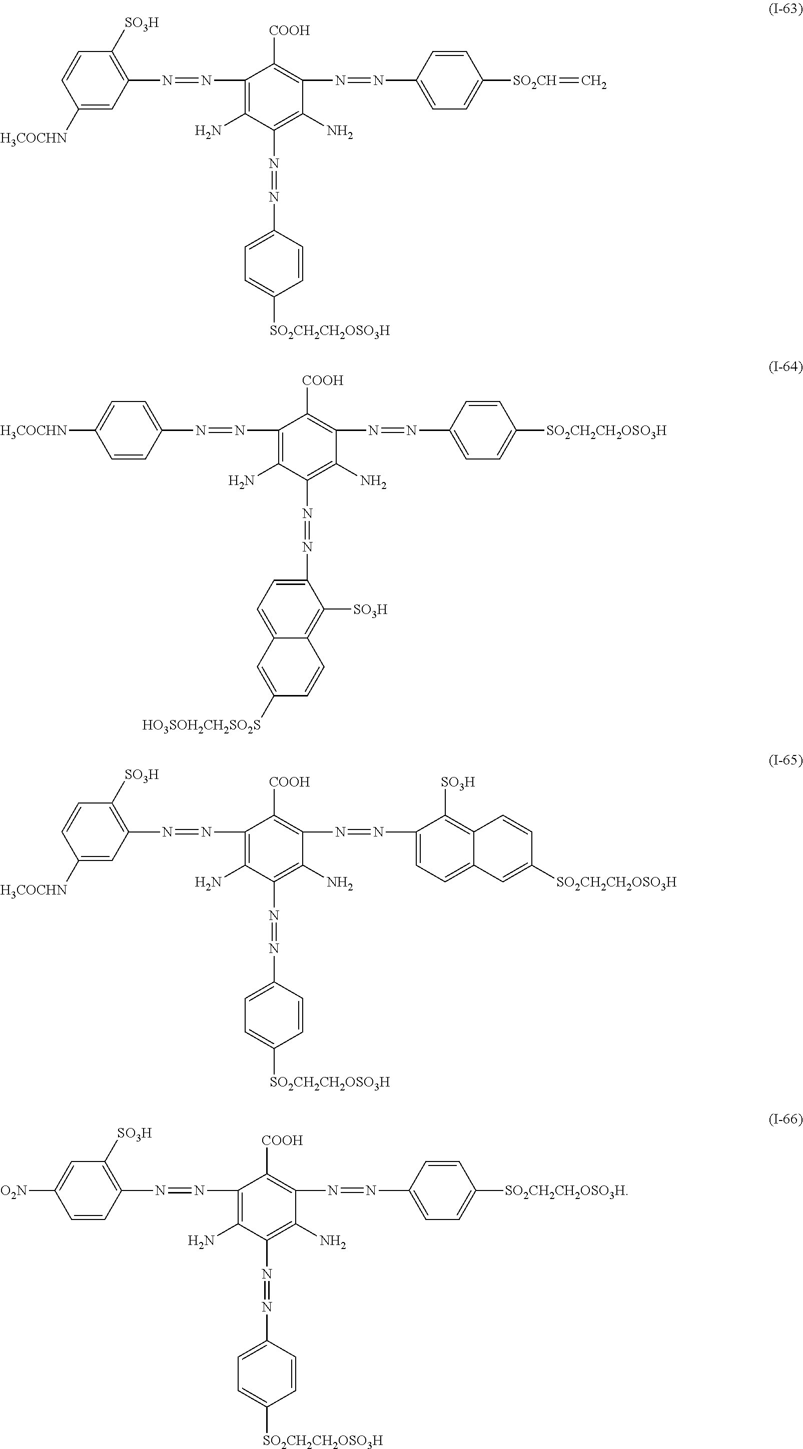

9. The reactive dye compound as claimed in claim 1, wherein the alkali metal salt is sodium salt or potassium salt.

10. A preparation method of the reactive dye compound as claimed in claim 1, comprising:
(1) diazotization reaction:
according to needs, the aromatic amine compounds of formulae (IIa), (IIb) and/or (IIc) are subjected to diazotization reaction, respectively, thereby obtaining corresponding diazonium salts;
(2) coupling reaction:
3,5-dihydroxybenzoic acid is added with water and beaten, and the resulting 3,5-dihydroxybenzoic acid solution is subjected to the first coupling reaction with the diazonium salt of the aromatic amine compound formula (IIa) obtained in the step (1), then the first-coupling product is subjected to the second coupling reaction with the diazonium salt of the aromatic amine compound formula (IIb) or (IIc) next, the second-coupling product is subjected to the third coupling reaction with the diazonium salt of the aromatic amine compound formula (IIb) or (IIc), thereby obtaining the reactive dye compound; 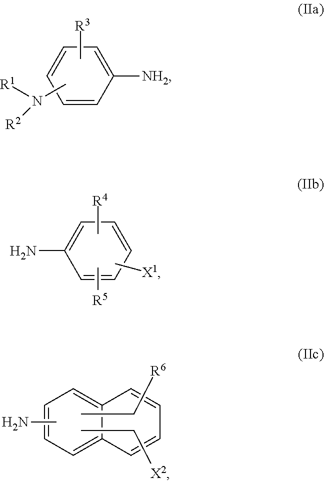
each substituent of formulae (IIa)˜(IIc) is the same as defined in formula (I).

11. The preparation method as claimed in claim 10, wherein the preparation method of the reactive dye compound are specifically as follows:
(1) diazotization reaction:
according to needs, the aromatic amine compounds of formulae (IIa), (IIb) and/or (IIc) are each beaten with ice water for 1 to 2 hours; after the beating, a certain amount of hydrochloric acid is added, and then a sodium nitrite solution is added within 20-30 min, the diazotization reaction is carried out by controlling pH at between 0.5 and 3.0 and temperature T at between 0° C. and 30° C., the end point of the reaction is detected with an ethanol solution of 4-dimethylaminobenzaldehyde; after the end point is reached, excess sodium nitrite is eliminated with sulfamic acid, and the diazonium salt solution of aromatic amine compound of the formula (IIa), (IIb) or (IIc) is obtained and stored for use; wherein the molar ratio of the aromatic amine compound of formula (IIa), (IIb) or (IIc) to hydrochloric acid and sodium nitrite is 1:(1-3):(1-1.1), preferably is 1:(1-1.8):(1-1.05);
(2) coupling reaction:
first, 3,5-diaminobenzoic acid is dissolved with water, the pH of the solution is controlled to be between 8.0 and 12.0, and the temperature of the solution is controlled to be between 15° C. and 25° C.; the dissolved 3,5-diaminobenzoic acid solution is added to the diazonium salt solution of the aromatic amine compound of formula (IIa) prepared in the above step (1), the pH is controlled to be between 2.0 and 6.0 with liquid alkali or baking soda, the temperature is controlled to be between 0° C. and 20° C., and the first coupling reaction is carried out, the first reaction solution is tested with H acid test solution, if the bleed circle is colorless, it means that the diazonium has been reacted completely to the end point, thereby obtaining coupling product 1;
second, the diazonium salt solution of formula (IIb) or (IIc) prepared in step (1) is added to coupling product 1, the pH is controlled to be between 5.0 and 8.0 with liquid alkali or baking soda, the temperature is controlled to be between 0° C. and 20° C., and the second coupling reaction is carried out, the second reaction solution is tested with H acid test solution, if the bleed circle is colorless, it means that the diazonium has been reacted completely to the end point, thereby obtaining coupling product 2;
third, the diazonium salt solution of formula (IIb) or (IIc) prepared in step (1) is added to coupling product 2, the pH is controlled to be between 5.0 and 8.0 with liquid alkali or baking soda, the temperature is controlled to be between 0° C. and 20° C., and the third coupling reaction is carried out, the third reaction solution is tested with H acid test solution, if the bleed circle is colorless, it means that the diazonium has been reacted completely to the end point, thereby obtaining the reactive dye compound;
wherein the molar ratio of the aromatic amine compounds of formula (IIa), (IIb) or (IIc) in every coupling to 3,5-diaminobenzoic acid is controlled to be (0.95-1.2):1.

12. A method for applying of the reactive dye compound as claimed in claim 1 in printing and dyeing of cellulosic fibers, polyamide fibers and fabrics thereof.
